(19) United States
(12) Patent Application Publication
(10) Pub. No.: US 2019/0294345 A1
(43) Pub. Date: Sep. 26, 2019

(54) Data-Retention Controller Using Mapping Tables in a Green Solid-State-Drive (GNSD) for Enhanced Flash Endurance

(71) Applicant: Super Talent Technology Corp., San Jose, CA (US)

(72) Inventors: Frank Yu, Palo Alto, CA (US); Abraham C. Ma, Fremont, CA (US); Shimon Chen, Los Gatos, CA (US); Yao-Tse Chang, Taichung City (TW); Yan Zhou, Wuhan City (CN)

(21) Appl. No.: 15/928,014

(22) Filed: Mar. 21, 2018

(51) Int. Cl. G06F 3/06; G06F 12/1009

(52) U.S. Cl. CPC G06F 3/0616; G06F 12/1009; G06F 3/0656; G06F 2212/22; G06F 3/0685; G06F 2212/1036; G06F 2212/2022; G06F 3/0658

(57) ABSTRACT

A Green NAND SSD (GNSD) controller receives reads and writes from a host and writes to flash memory. A SSD DRAM has a DRAM Translation Layer (ETL) with buffers managed by the GNSD controller. The GNSD controller performs deduplication, compression, encryption, high-level error-correction, and grouping of host data writes, and manages mapping tables to store host write data in the SSD DRAM to reduce writes to flash memory. The GNSD controller categorizes host writes as data types for paging files, temporary files, meta-data, and user data files, using address ranges and file extensions read from meta-data tables. Paging files and temporary files are optionally written to flash. Full-page and partial-page data are grouped into multi-page meta-pages by data type before storage by the GNSD controller. Status bits include two overwrite bits indicating frequently-written data that is retained in the SSD DRAM rather than being flushed to flash and re-allocated.

### RELATED APPLICATIONS

This application is related to “Endurance and Retention Flash Controller with Programmable Binary-Levels-Per-Cell Bits Identifying Pages or Blocks as having Triple, Multi, or Single-Level Flash-Memory Cells”, U.S. Pat. No. 9,123,422, filed on Mar. 7, 2013; “Virtual Memory Device (VMD) Application/Driver with Dual-Level Interception for Data-Type Splitting, Meta-Page Grouping, and Diversion of Temp Files to Ramdisks for Enhanced Flash Endurance”, U.S. Pat. No. 8,954,654, filed on Dec. 28, 2012; “Super-Endurance Solid-State Drive with Endurance Translation Layer (ETL) and Diversion of Temp Files for Reduced Flash Wear”, U.S. Pat. No. 8,959,280, filed on Jul. 2, 2012; “High Performance and Endurance Non-volatile Memory Based Storage Systems”, U.S. Ser. No. 12/141,879, filed Jun. 18, 2008; and “Green NAND Device (GND) Driver With DRAM Data Persistence For Enhanced FLASH Endurance And Performance”, U.S. Pat. No. 9,223,642, filed Jun. 26, 2013; and “Green NAND SSD APPLICATION AND DRIVER”, U.S. Pat. No. 9,389,952, filed Nov. 17, 2014, in which each of the foregoing disclosures is hereby incorporated by reference herein in its entirety, and all of which are assigned to the same assignee hereof.

### FIELD OF THE INVENTION

This invention relates to flash-memory systems, and more particularly to increased-endurance and longevity of flash memory drives.

### BACKGROUND OF THE INVENTION

Flash memory is widely used for peripheral storage in computer systems, and for primary storage in portable devices. NAND flash memory, invented by Dr. Fujio Masuoka of Toshiba in 1987, uses electrically-erasable programmable read-only memory (EEPROM) cells that store charge on a floating gate. Cells are typically programmed by an avalanche current, and then erased using quantum-mechanical tunneling through a thin oxide. Unfortunately, some electrons may be trapped in the thin oxide during program or erase. These trapped electrons reduce the charge stored in the cell on subsequent program cycles, assuming a constant programming voltage. Often the programming voltage is raised to compensate for trapped electrons.

As the density and size of flash memory has increased, the cell size has been shrunk. The thickness of oxides including the tunneling oxide has also been reduced. The thinner oxides are more susceptible to trapped charges and sometimes fail more easily. The floating gate of NAND flash is used to trap electrons. The number of electrons in the floating gate can affect the voltage level of the output. The different level of voltage is achieved by controlling the number of electrons trapped in the depletion layer during the write process. The ever smaller floating gate area often limits the maximum number of electrons that can be trapped (now just several hundred electrons). Due to program/read interference the electrons can leak or trap into the floating gate. This electron number change will affect the voltage output level change and change the read result.

The number of program-erase cycles that a flash memory is guaranteed to be able to withstand was around 100,000 cycles, which allowed for a lengthy lifetime under normal read-write conditions. However, the smaller flash cells have experienced a disturbingly higher wear and newer flash memories may be spec'ed at less than 10,000 program-erase cycles for two-level cells and about 600 for Triple-Level Cells (TLC). If current trends continue, future flash memories may only allow for 300 program-erase cycles. Such a low endurance could severely limit the applications that flash memory could be used for, and have severe impacts for Solid-State-Disk (SSD) applications.

One method to increase the density of flash memory is to store more than one bit per memory cell. Different voltage levels of the cell are assigned to different multi-bit values, such as four voltage ranges for a two-bit cell. However, the noise margins are reduced for the multi-level-cell (MLC) and TLC flash technologies and endurance problems are exacerbated.

It is likely that the underlying flash technology will have lower endurance in the future. Flash drives may compensate for the lower wear tolerance of the underlying flash memories by a variety of techniques. For example, a DRAM buffer on the flash drive may act as a write back cache, reducing the number of writes to the underlying flash memories when the host performs writes to the same data location.

What is desired is a controller for a flash drive that compensates for lower wear tolerances of the underlying flash memory devices. A Green NAND SSD (GNSD) controller in a GNSD drive with flash memory and DRAM is desired that uses advanced management techniques that together reduce the number of writes to flash, hence reducing program-erase cycles on the underlying flash memory. A GNSD controller that controls a GNSD drive constructed from low-endurance flash memory is desired.

### BRIEF DESCRIPTION OF THE DRAWINGS

FIG. 1 is a detailed diagram highlighting the GNSD controller in the GNSD SSD drive.

FIG. 2 is a flow diagram showing data splitting and grouping for writes through the GNSD controller.

FIG. 3 is a flow diagram showing data sorting and un-grouping for reads through the GNSD controller.

FIG. 4 shows a memory map which is a DRAM Translation Layer (DTL) showing various types of data stored.

FIG. 5 is a diagram of a status field in a mapping table.

FIGS. 6A-C show the operation of mapping tables for various reads and writes to the GNSD drive.

FIG. 7 shows a flush operation that updates the mapping table.

FIGS. 8A-C show a read operation using the mapping tables of FIGS. 5-7.

FIGS. 9A-F show a write operation using the mapping tables of FIGS. 5-7.

FIGS. 10A-D shows an auto flush operation.

FIG. 11 is a routine to find a next available DRAM unit.

### DETAILED DESCRIPTION

The present invention relates to an improvement in Green NAND SSD (GNSD) controllers. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

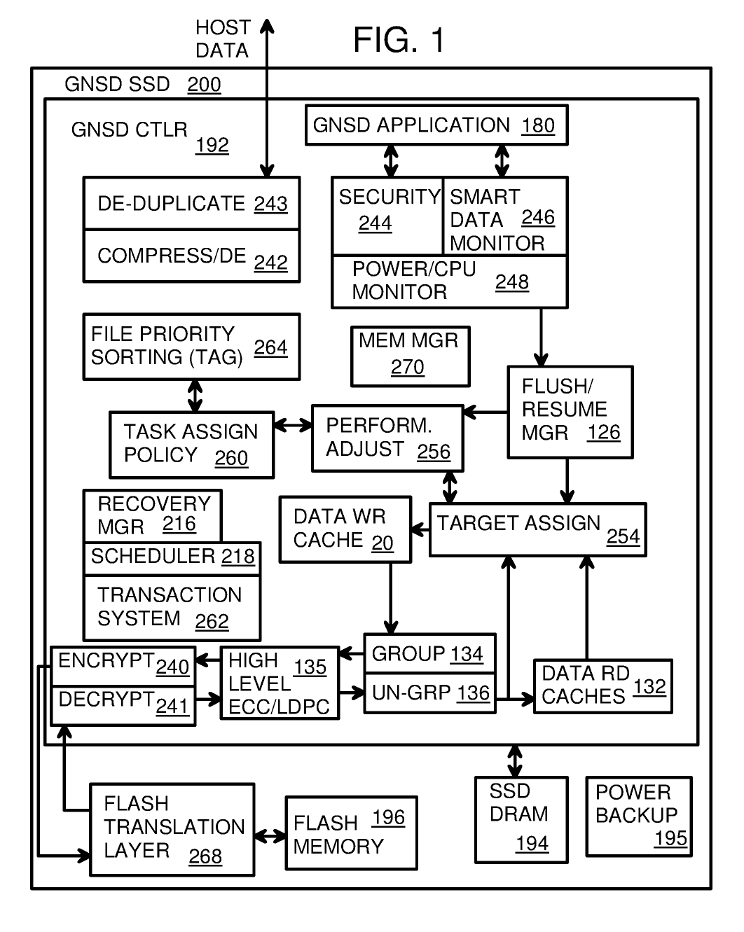

FIG. 1 is a detailed diagram highlighting the GNSD controller in the GNSD SSD drive. Host data written by the OS kernel is passed to GNSD drive 200 and then to GNSD controller 192 for data deduplication by deduplication engine 243 and then for compression by compression engine 242.

File priority sorting 264 sorts the data based on the data type indicated by the LBA, such as for meta-data (FAT, FDB), temp files, paging files, or user data. Temp files include windows temporary files, internet browser temporary files, etc. Alternately, this function can be optionally disabled for certain uses such as a server. Operations are given a priority by task priority assignor 260 so that higher priority tasks may be performed ahead of lower-priority tasks. Performance adjustor 256 may periodically adjust these priorities to improve performance. Target assignor 254 then sends the data to data write cache 20, depending on the data type.

Data that is written to flash memory 196 in GNSD drive 200 may be grouped by grouper 134 before being sent. Ungrouper 136 ungroups data that was retrieved from flash memory 196 before being transferred to data read caches 132.

Transaction system 262 ensures that data is written completely to flash memory 196 in GNSD drive 200. Recovery manager 216 determines which write transactions were not completed due to abnormal power off, and helps applications to do the necessary redo or undo to make the data persistent. Scheduler 218 manages transaction system 262 to manage and record write to SSD transactions such as start, abort, and commit.

When power monitor 248 detects a power down or failure, it activates flush/resume manager 126 to transfer data from data write cache 20 to GNSD drive 200 for storage in flash memory 196. When the flush is done, flush/resume manager 126 will issue a command to flash memory 196 and backup power supply 195. Backup power supply 195, if present, will provide power to the GNSD SSD to back up the hot data from SSD DRAM 194 to flash memory 196.

Flush/resume manager 126 may periodically flush the contents of data write cache 20 to flash memory 196 before power is lost. Security 244 may perform a password verification process before allowing access to flash memory 196 or data cached in SSD DRAM 194. Smart data monitor 246 sends S.M.A.R.T. monitoring information from flash memory 196 to GNSD application 180. GNSD application 180 can be implemented in firmware by GNSD controller 192 and can be customized for the size of flash memory 196 and SSD DRAM 194.

Memory manager 270 uses mapping tables to control access to SSD DRAM 194. Flash translation layer 268 controls access to flash memory 196.

High-level ECC/LDPC controller 135 generates and appends error-correction code (ECC) to writes, and checks and removes ECC for reads. Encryption can be performed by encryptor 240 and decryption performed by decryptor 241 for data stored on flash memory 196.

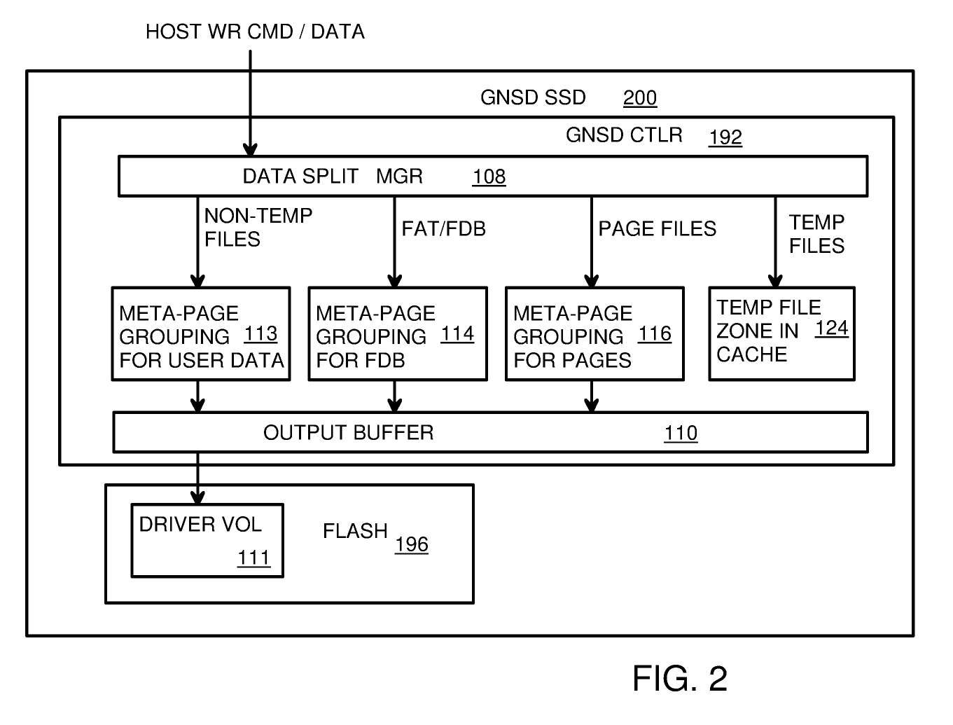

FIG. 2 is a flow diagram showing data splitting and grouping for writes through the GNSD controller. The host's write command is sent by GNSD controller 192 in GNSD drive 200 to data split manager 108, which also receives host write data after compression or encryption by compression/encryption engine 242 if enabled. A compression table entry for the encrypted or compressed files may be modified in meta-data cache 120.

Data split manager 108 inside GNSD controller 192 sorts the host write data by data type, such as by examining the file extension or by parsing the FAT and FDB. Temp files are stored in Temp file zone 124 in cache. Temp files are not stored to flash and are lost when power turns off and fails. The temp file zone can be optionally overflowed and grouped to SSD. Alternately, this function can be optionally disabled for certain operations such as server.

Paging files are stored in a paging zone in the cache and are grouped with other pages containing the same paging file data type into meta-pages by paging file grouping process 116. The grouped pages are then sent through output buffer 110 to driver volume 111 in flash memory 196 and may be stored in DRAM, then flash memory. ECC code may be generated and attached by output buffer 110.

Meta-data files such as FAT and FDB entries are routed by data split manager 108. The FDB may be grouped into meta-pages by FDB meta-page grouping process 114. The grouped pages are then sent through output buffer 110 to flash memory 196 and may be stored in DRAM. ECC code may be generated and attached by output buffer 110.

User files are grouped with other pages containing the same user or non-temporary file data type into meta-pages by meta-page user file grouping process 113. The grouped pages are then sent through output buffer 110 to flash memory 196 and may be stored in DRAM, then flash memory. ECC code may be generated and attached by output buffer 110.

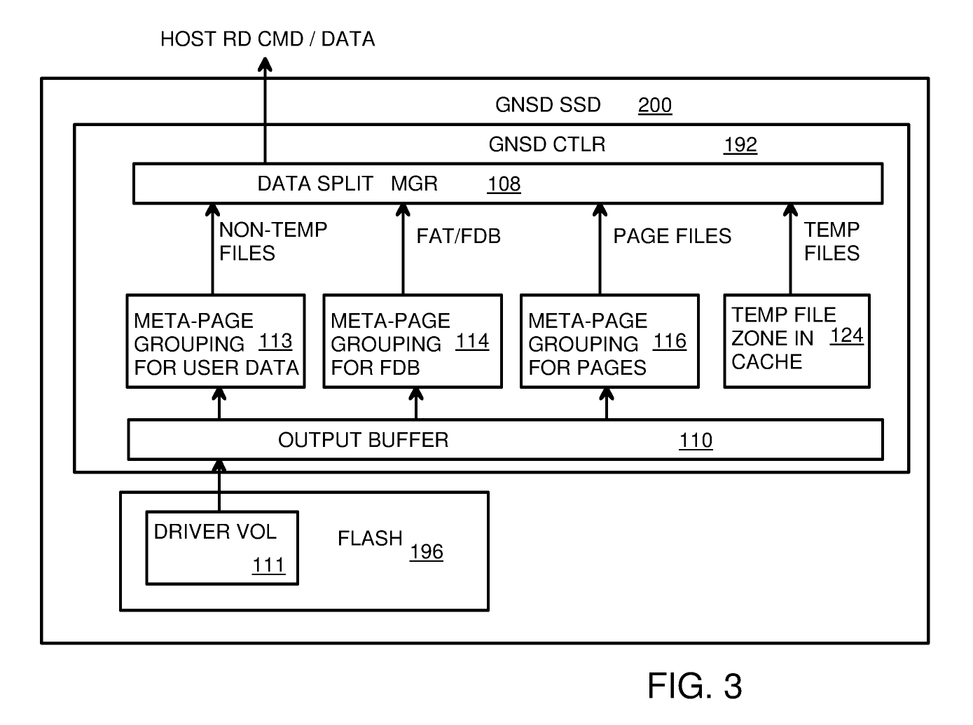

FIG. 3 is a flow diagram showing data sorting and un-grouping for reads through the GNSD controller. In a power-down mode, SSD driver volume 111 in flash memory 196 provides user or non-temporary file data type in meta-pages grouped by meta-page user file grouping process 113. SSD driver volume 111 also provides paging file data type grouped into meta-pages by paging file grouping process 116, and File Description Block (FDB) data grouped into meta-pages by FDB meta-page grouping process 114. Temp files are stored in Temp file zone 124 in a cache and are lost, once power to the cache is depleted. FDB data can include a directory, subdirectory, FAT1, FAT2, etc.

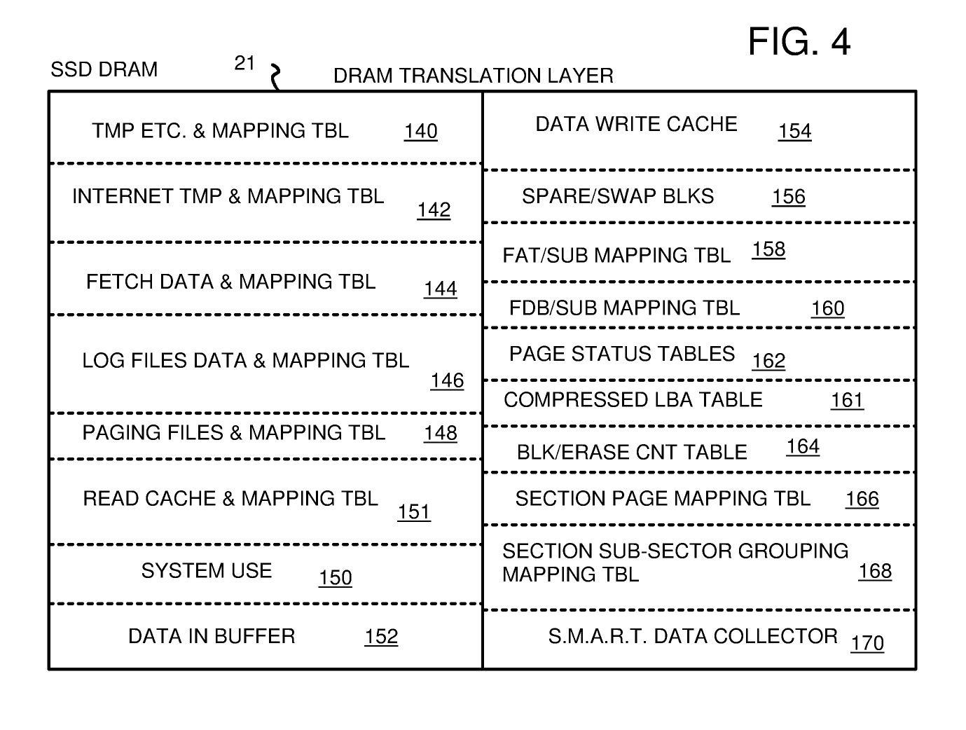

FIG. 4 shows a memory map which is a DRAM Translation Layer (DTL) showing various types of data stored in DTL DRAM 21, which also may be shown in FIG. 1 as SSD DRAM 194. DTL DRAM 21 may represent a portion of SSD DRAM 194. The firmware of GNSD controller 192 uses the DTL to manage the interaction of DTL DRAM 21 of DRAM 194 and Flash Memory 196, at power up, during normal operation, and power down. Temp area 140 in DTL DRAM 21 stores temporary files that are identified by reading the file extension in the FDB/FAT that is stored in FAT area 158 or FDB area 160. Temp files can be those with extensions of .tmp, .temp, .tmt, .tof, .trs, .tst, etc. System related temp files may include ._mp, .log, .gid, .chk, .old, .bak. AutoCAD related temp files may include .SV$, .DWL, .AC$. Word related temp files may include .asd files. Excel related temp files may include .xar files. Other applications may use their own unique file extension for temp files. Internet temp file area 142 stores files with an extension of .gif, .jpg, .js, .htm, .png, .css, .php, .tmp, .mp3, .swf, .ico, .txt, .axd, .jsp, and .aspx. Both areas 140, 142 have a table for locating each temp file. This table may be indexed by the logical address from the host.

Fetch data area 144 stores fetch data and a table of entries in fetch data area 144. Each time a computer is turned on, the Windows® OS keeps track of the way the computer starts and which programs are commonly open. Windows® OS saves this information as a number of small files in the prefetch folder. The next time the computer is turned on, Windows® OS refers to these files to help speed the start process.

The prefetch folder is a subfolder of the Windows® OS system folder. The prefetch folder is self-maintaining, and there's no need to delete it or empty its contents. Log files with an extension of .log or .evt are stored in log file area 146, which also may have a mapping table for log files stored in this area, or may be considered a type of temp file.

Paging files that swap data between main memory on the host at peripheral storage such as a hard disk or GNSD drive 200 are stored and mapped in paging area 148. A read cache of data read from flash memory 196 and stored in DTL DRAM 21 is placed in read cache area 151. A mapping table of read cache entries may be used, and include tags, valid bits, and pointers to the data in flash memory 196. System area 150 stores flash system data used by the operating system of GNSD controller 192. Data in buffer 152 stores the raw host data (including the LBA) being written to GNSD drive 200. The actual host data is later moved to data write cache 154 before being written into flash memory 196. Super write cache technology related to data write cache 154 is used to cache the write data to flash memory 196 for the purpose of reducing the number of writes/erases to flash memory 196 and with Spare/Swap blocks 156 further to reduce the writes/erases in flash memory 196.

The data write from the host will write into data in buffer 152 first, then after processing by GNSD driver 100 such as compression, it will write to data write cache 154, then write to flash memory 196. In the case of a large quantity of data continuously writing from the host, writes to flash memory 196 may be a bottleneck. The data can be continuously written into data write cache 154 until it is full, then the flow from data in buffer 152 to data write cache 154 will be stopped. If data in buffer 152 is also full, then the host will be notified to stop the traffic.

Data write cache 154 uses an endurance write cache algorithm that stores write data to DTL DRAM 21 and not flash memory 196 until castout. Thus multiple writes with the same LBA can overwrite the data in data write cache 154 and write to flash memory 196 in a stripe-ready unit according to the policy (such as based on time elapsed, capacity allocated, etc.) or upon power off or power failure. Data write cache 154 also holds the partial page write data until the whole page is grouped with multiple partial pages. Thus, multiple partial pages write can write to flash memory 196 according to policy (such as based on time elapsed, capacity allocated, etc.) or upon power off or power failure.

In a multi-channel controller structure, device controller 192 may write data which is arranged as multiple pages (the number of the multiple may be equivalent to the multichannel) from data write cache 154 to flash in a stripe-ready unit when castout to best utilize the flash interface bandwidth. For each device controller 192, it consists of the number of channels C, each channel has a number F of flash chips attached, each chip has D dies in a stack, and each die has P planes. The stripe size can be set to be F*D*P pages. The stripe depth can be set to C*F*D*P pages. The device controller 192 selects the data from data write cache 154 and writes the data to the selected stripes of flash memory 196, then updates related mapping table entries with corresponding PBA address. Each channel has only one bus, so only one die can be accessed. F*D dies will be interleaved to share the bus to maximize the utilization of the bus. The size of the stripe-ready unit can be C or up to C*F*D*P pages.

A DRAM Translation Layer (DTL) method increases endurance of a flash memory that has a low specified erase-cycle lifetime. A flash memory interface has a multiple of buses for channels; each channel has a multiple of flash chips; each chip has a multiple of dies, and each die has multiple planes. All channels can be accessed at the same time. All dies in the same channel cannot be accessed at the same time; only one die in the same channel can be accessed at a time. Another die in a channel can be accessed when the other die is being written or read. Interleaving writing or reading can increase the performance of flash access. A data write cache is stored in the DRAM buffer and managed by the controller according to a policy. When the dirty data in the data write cache is greater than the stripe-ready unit, the device controller manages the dirty data and writes to the flash memory through the flash memory interface. The device controller manages the distribution of data to each channel of flash memory. The device controller manages the interleaving of data to one die of one chip in each channel, and manages the mapping table entries to track the LBA to PBA mapping.

In other alternate designs, in a multi-channels controller structure, each channel may have its own data write cache 154. Writing stripe-ready units simultaneously to each flash memory channel can maximize the flash memory interface speed. User file data can be identified as Frequent Access data based on the hit rate of >=n (such as 2) and Non-Frequent Access data of hit rate <n. They may be written to two data write caches 154 separately. Multiple write data with the same LBA address to a Frequent Access Zone will overwrite the old contents in DRAM that is not in flash so that it reduces the number of writes to flash memory 196. The cache data in the Frequent Access Zone of the data write cache will be stored in flash memory 196 in a stripe-ready unit based on a policy such as based on time elapsed (such as 1 hour), capacity allocated, etc., or upon power off or power failure. The cache data in the Non-Frequent Access Zone of the data write cache will be stored to the flash memory 196 in a stripe-ready unit based on another policy such as based on time elapsed (such as 15 minutes), capacity allocated, etc. or upon power off or power failure.

In the case of LBA address misalignment, the LBA address will be added with an offset to make the LBA address aligned with the page address of flash memory 196 before writing to data write cache 154 to make the write to flash more efficient later on.

Endurance spare and swap blocks 156 are used for the garbage collection function to consolidate the valid data and evicted data from the write cache before it is written to flash. Page status tables 162 contain a table with page status entries, such as an empty page, a used page, a garbage page (TRIMed), a bad page, and a page that needs additional ECC protection. Compressed LBA table 161 stores mapping entries for compressed user data. Block erase count table 164 keeps track of erase counters and block status for each physical block in flash memory 196.

Section page mapping table 166 stores partial-page mapping information. DRAM 21 may not have enough space for the whole mapping table, so only portion of it is loaded to the DRAM. When the LBA table entry is not in the DRAM then it will evict some portion of the partial mapping table and load the related LBA table to DRAM. Section sub-sector grouping mapping table 168 stores sub-sector mapping information for data files that are less than one page in size. A partial mapping table of sub-sector grouping mapping table 168 has entries for only 1 of N sets of mapping tables. The other N−1 sets are stored in flash memory and fetched into the DRAM buffer when a partial mapping table miss occurs.

S.M.A.R.T data collector 170 has data tables and other information used by SMART function 39 from SMART monitor 246 (FIG. 1) and can be requested by the host through SMART commands or vendor commands.

The sizes of the areas in DTL DRAM 21 may be determined by the overall size of DTL DRAM 21, the page size, block size, and sector size of flash memory 196, and whether page mapping or block is used, or an estimate of what percent of the entries in that area are page mapped rather than block mapped. For example, DTL DRAM 21 may be a 512 MB DRAM, with 240 MB allocated to temp area 140, 160 MB allocated to Internet temp area 142, 12 MB allocated for fetch data, 6 MB allocated for log files, etc.

In a multi-channel controller structure, device controller 192 may read data from flash memory 196 and go through the multi-channel structure to various DTL tables (FAT/Sub Mapping Table 158, FDB/Sub Mapping Table 160, Page Status Table 162, compressed LBA Table 161, block erase count table 164, Section Page Mapping Table 166, and Section Sub-Sector Grouping mapping Table 168).

In a multi-channel controller structure, device controller 192 may write various DTL tables (FAT/Sub Mapping Table 158, FDB/Sub Mapping Table 160, Page Status Table 162, Compressed LBA Table 161, block erase count table 164, Section Page Mapping Table 166, and Section Sub-Sector Grouping mapping Table 168) which are arranged as multiple pages, (the number of multiple is equivalent to multi-channel) to flash in stripe-ready units according to a policy (such as based on time elapsed, capacity allocated, etc.) or upon power off or power failure, to best utilize the flash interface bandwidth.

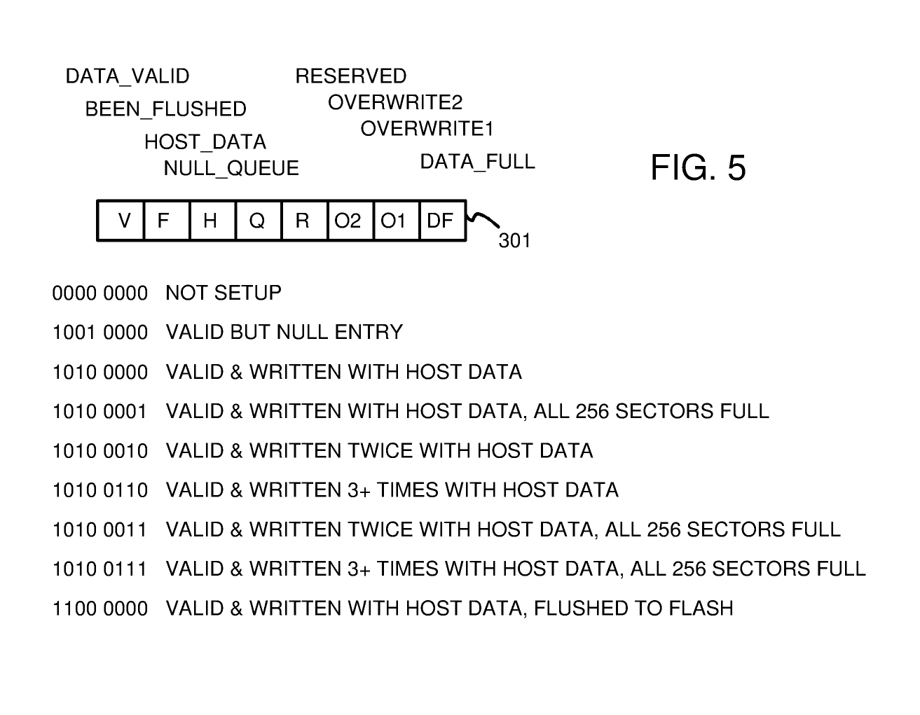

FIG. 5 is a diagram of a status field in a mapping table. Status field 301 can be part of one of the mapping tables in DTL DRAM 21 of FIG. 4. The mapping tables can include tables 140, 142, 144, 146, 148, 161, and 165 of FIG. 4. FIG. 5 to FIG. 11 are examples of mapping tables and flow charts for a simplified mapping table for these tables and for data write cache 154. The data_valid bit V is set for any entries that are part of the mapping table, and cleared for entries that are not allocated to or setup for the mapping table. The been-flushed bit F is set when the entry has been flushed and its data back written to flash memory. The host_data bit H is set when host data is written to the entry, but cleared on a flush. Thus the host_data bit H indicates that the DRAM entry has the most-current write data that has not yet been copied to flash memory.

The null_queue bit Q is set when a DRAM entry has been allocated and set up, but not yet written with host data. The DRAM entry is empty of host data. The reserved but R is unused. The data_full bit F is set when all 256 sectors in an DRAM entry have been written with host data. The data_full bit F is cleared on a flush.

The overwrite_1 bit O1 is set when a second host write is performed to a DRAM entry. The overwrite_2 bit O2 is set when a third host write is performed to a DRAM entry. These overwrite bits are set even when the data writes are to different sectors in a DRAM entry. These overwrite bits are cleared on a flush. These overwrite bits are useful for identifying frequently-used data. Entries for frequently-used data can be kept in the mapping table while mapping entries for seldom-accessed data can be removed during a flush. This can improve performance.

Thus status bits of 0000 0000 indicate a DRAM entry that is not set up or allocated to the mapping table, and 1001 0000 indicates a valid but empty entry. When a first host write occurs, the status bits for the corresponding mapping entry change to 1010 0000, and a subsequent write changes the status to 1010 0010, while a 3^{rd} write changes the status to 1010 0110. When all 256 sectors have been written for an entry, the status changes to 1010 0001 if only one write has occurred, or to 1010 0011 if two write have occurred, or to 1010 0111 if three or more writes have occurred to fill all 256 sectors.

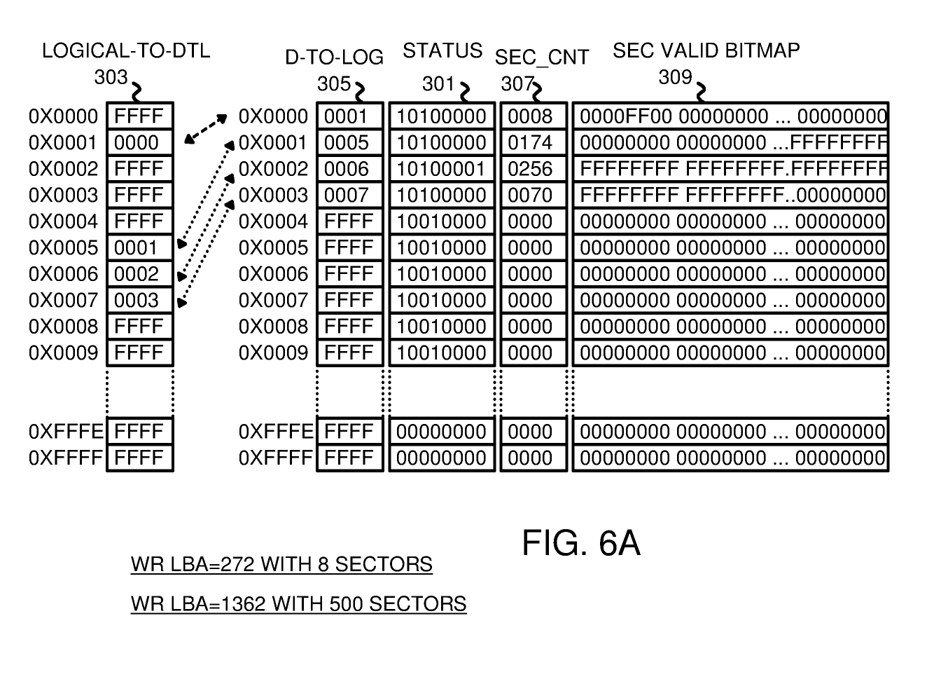

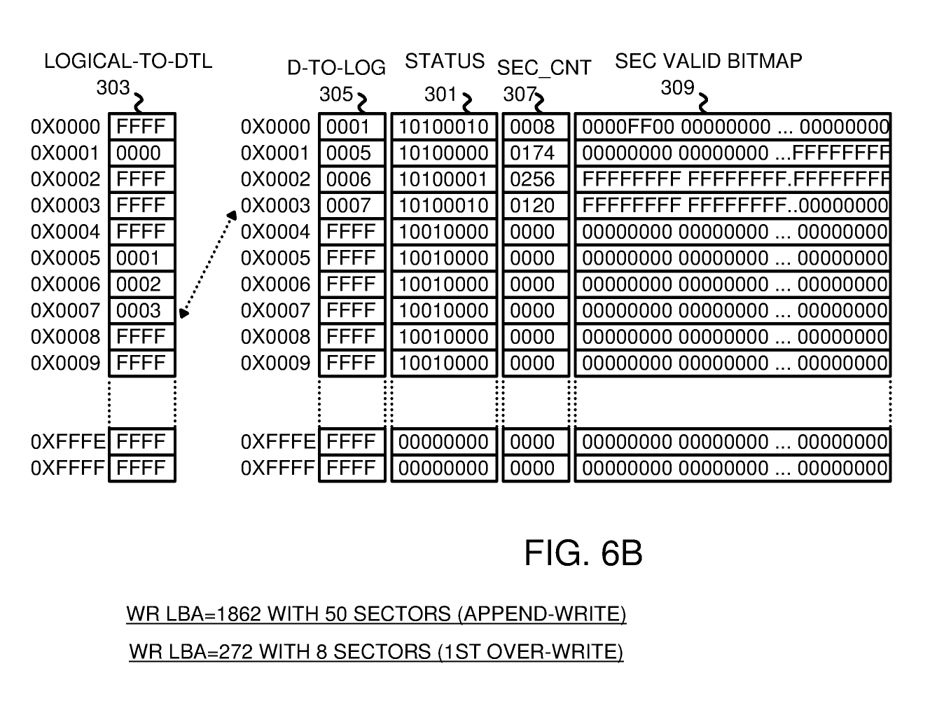

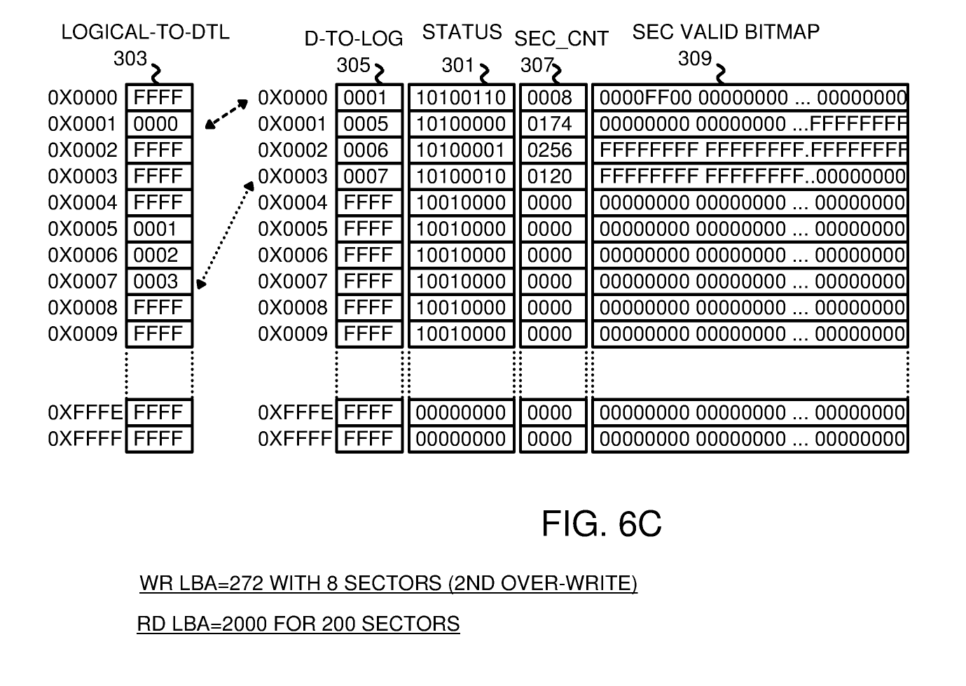

FIGS. 6A-C show the operation of mapping tables for various reads and writes to the GNSD drive. In FIG. 6A, the mapping tables are initialized by setting all address fields to a null value of FFFF. This includes logical-to-DTL table 303 and DTL-to-logical address field 305. All the sector valid bitmaps are cleared for sector valid bitmap 309. The sector counts are also cleared in sector count field 307. The status bits are cleared for all entries, and then status field 301 is set to 1001 0000 for all entries that are allocated to the mapping table.

DTL-to-logical address field 305, status field 301, sector count field 307, and sector valid bitmap 309 are all part of a DTL-to-logical address table that is addressed by a pointer value that is stored in the entries in logical-to-DTL table 303. A portion of the logical address from the host is used to select one of the entries in logical-to-DTL table 303. Each entry refers to a portion of memory that is referred to as a DRAM unit.

In this example, the DRAM unit is 256 sectors of 512 bytes per sector, for a total of 128K bytes per DRAM unit. Each entry in the mapping table has 256 bits in sector valid bitmap 309 to control the 128K bytes of data storage.

For a 2T byte flash memory, there are 2T/128K or 16M possible logical units. For a full map, logical-to-DTL table 303 needs 16M entries. For a 16-bit entries in logical-to-DTL table 303, the total memory size needed for logical-to-DTL table 303 is 16M×16 bits or 32M bytes.

The DRAM allocated to the mapping table is smaller, since the DRAM size is smaller than the flash memory size and only a portion of DRAM can be used for this application. Thus a relatively few entries in the DTL-to-logical table are available. For example, the DTL-to-logical mapping table might be only 4G byte in size.

The size of each entry in the DTL-to-logical table includes 32 bits for the address stored in DTL-to-logical address field 305, one byte for status field 301, two bytes for sector count field 307, and 256 bits or 32 bytes for sector valid bitmap 309. This is a total of 39 bytes per entry. When 32K entries are allocated for the DTL-to-logical address table, the memory size is about 1.2M bytes. Many other sizes and arrangements are possible.

Since only 32K entries are allocated, the first entries in DTL-to-logical address field 305 are allocated and their status set to 1001 0000 in status field 301 during initialization. The last 32K entries, including 0xFFFF, have their status cleared in DTL-to-logical address field 305.

In this example sequence, after initialization, a host write to LBA 272 that has 8 sectors of data occurs. In this example the logical address (LBA) from the host is a sector address not a block address. Thus the host is writing 8 sectors, starting at the 272^{nd} sector. The logical DRAM unit is 272/256 or 1, with a remainder of 16, so this write is to entry #1 (0x0001) in logical-to-DTL table 303, and has a starting sector offset of 16.

The first entry in the DTL-to-logical address table is allocated, which has an address of 0x0000, so the address of 0000 is entered into the second entry in logical-to-DTL table 303. Thus entry 0x0001 in logical-to-DTL table 303 points to entry 0x0000 in the DTL-to-logical table.

The address of the second entry of logical-to-DTL table 303, 0001, is entered into DTL-to-logical address field 305 for the allocated entry in the DTL-to-logical table. The host_data bit is set and the null_queue bit is cleared in this entry's status field 301, so its status is now 1010 0000. Since the host write is for 8 sectors, the sector count in sector count field 307 is set to 8. Since the starting sector offset is 16, bits 16 to 23 are set in sector valid bitmap 309, so that the bitmap is now 0000FF00 00000000 . . . 00000000.

The next operation is a larger host write of 500 sectors to logical address 1362. The first logical unit is 1362/256 or 5, with a remainder of 82. This entry #5, address 0x0005 in logical-to-DTL table 303 is selected. The next available empty entry in the DTL-to-logical table is the second entry at 0x0001, so 0001 is loaded into logical-to-DTL table 303 for 0x0005, and 0005 is loaded into DTL-to-logical address field 305 for entry 0x0001.

Since there are 500 sectors in this write, a total of 3 DRAM units are required. So the next two entries are also allocated in both tables. The next entry #6, address 0x0006 in logical-to-DTL table 303 is linked to the next available empty entry in the DTL-to-logical table, the third entry at 0x0002, so 0002 is loaded into logical-to-DTL table 303 for 0x0006, and 0006 is loaded into DTL-to-logical address field 305 for entry 0x0002. The following entry #7, address 0x0007 in logical-to-DTL table 303 is linked to the next available empty entry in the DTL-to-logical table, the fourth entry at 0x0003, so 0003 is loaded into logical-to-DTL table 303 for 0x0007, and 0007 is loaded into DTL-to-logical address field 305 for entry 0x0003. Thus three entries are filled in logical-to-DTL table 303 with pointers to three entries in the DTL-to-logical table.

The host_data bit is set and the null_queue bit is cleared all three entries' status field 301, and the data_full bit is also set for the middle entry, since it will have all 256 sectors written by the long write operation. Thus the status is now 1010 0000 for entries 0x0001 and 0x0003, and 1010 0001 for the middle entry 0x0002 in the DTL-to-logical table. Sector count field 307 is written with 256 for the middle entry 0x0002, and with 174 for entry 0x0001 and with 70 for entry 0x0003. Since the starting sector offset is 82, there are 82 empty sectors before writing begins in unit 0x0001, with a total of 256−82 or 174 sectors written, so 174 is written into sector count field 307 for the first entry being written, 0x0001. After all 256 sectors are written in the middle DRAM unit, the final 500−174−256 or 70 sectors are written into the final DRAM unit, and 70 is written into sector count field 307 for the entry for DRAM unit 0x0003.

All 256 bits in sector valid bitmap 309 are set for the middle entry, and the last 174 bits in sector valid bitmap 309 are set for the first entry 0x0001, and the first 70 bits in sector valid bitmap 309 are set for the final entry 0x003.

In FIG. 6B, another 50 sectors are written to logical address 1862. These new sectors are just after the end of the prior write in FIG. 6A. The logical address is divided by 256 to get the logical unit # and address into logical-to-DTL table 303, or 1862/256=7, with a remainder of 70, which is the sector offset where writes begin. The entry at 0x0007 is selected from logical-to-DTL table 303 and found to contain 0003, a pointer to entry 0x0003 in the DTL-to-logical table. Entry 0x0003 is already valid, so the 50 new sectors are written into SSD DRAM 194 starting at a sector 71 and ending at sector 120. The sector count is updated to 70+50=120 for sector count field 307. In sector valid bitmap 309, bits 71-120 are set, in addition to bits 1-70 that are already set from the prior write.

Since this is the second write to this DRAM unit, the overwrite_1 bit is set in status field 301, so the status for entry 0x0003 is now 1010 0010.

Also in FIG. 6B, another host write is received, for 8 sectors at logical address 272. Since 272/256=1 with a remainder of 16, this maps to entry 0x0001 in logical-to-DTL table 303, which already has a pointer 0001 to entry 0x0001 in the DTL-to-logical table. Since this valid entry already has data written at sectors 16-23, these sectors are over-written with the new host data. The sector count does not change in sector count field 307, and the bitmaps do not change in sector valid bitmap 309. However, the overwrite 1 bit is set in status field 301 so that the status is now 1010 0010.

In FIG. 6C, still another host write for 8 sectors at logical address 272 is received. Since 272/256=1 with a remainder of 16, this again maps to entry 0x0001 in logical-to-DTL table 303, which already has a pointer 0001 to entry 0x0001 in the DTL-to-logical table. Since this valid entry already has data written at sectors 16-23, these sectors are over-written for a second time with the new host data. The sector count does not change in sector count field 307, and the bitmaps do not change in sector valid bitmap 309. However, the overwrite_2 bit is set in status field 301 so that the status is now 1010 0110. Having both overwrite bits set indicates that this entry has frequently-written data and should not be cast out of the DRAM cache.

Also in FIG. 6C, the host reads 200 sectors at logical address 2000. The starting entry is at 2000/256=7, with a remainder of 208, so entry 0x0007 is read from logical-to-DTL table 303. This entry has a pointer value of 0003, so entry 0x0003 in the DTL-to-logical table is accessed. The status bits indicate that this entry has valid data. However, sector valid bitmap 309 indicates that only the first 120 sectors are valid. However, the starting sector offset, the remainder of 208, is beyond the last valid sector in DRAM, so all 200 sectors are read from flash.

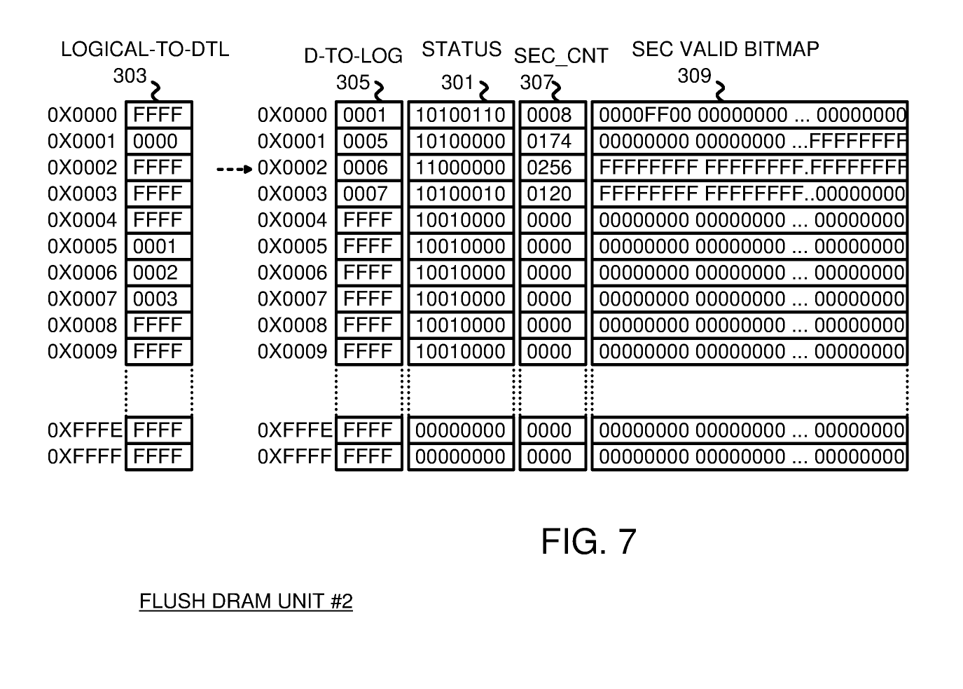

In FIG. 7, a flush operation updates the mapping table. Unit #2 in DRAM is flushed. This entry 0x0002 already has 256 sectors written, so these 256 sectors of data are copied from SSD DRAM 194 to flash memory 196 by the flush operation. After being copied to flash memory 196, the data remains in SSD DRAM 194. However, the been_flushed status bit is set. The host_data and data_full bits are cleared since the data was copied to flash. The status is updated to 1100 0000 after the flush. Sector count field 307 and sector valid bitmap 309 remain the same, so future reads and writes can more quickly access the flushed data since it is kept in SSD DRAM 194, but the entry can be mapped to a different host address and the data over-written as needed.

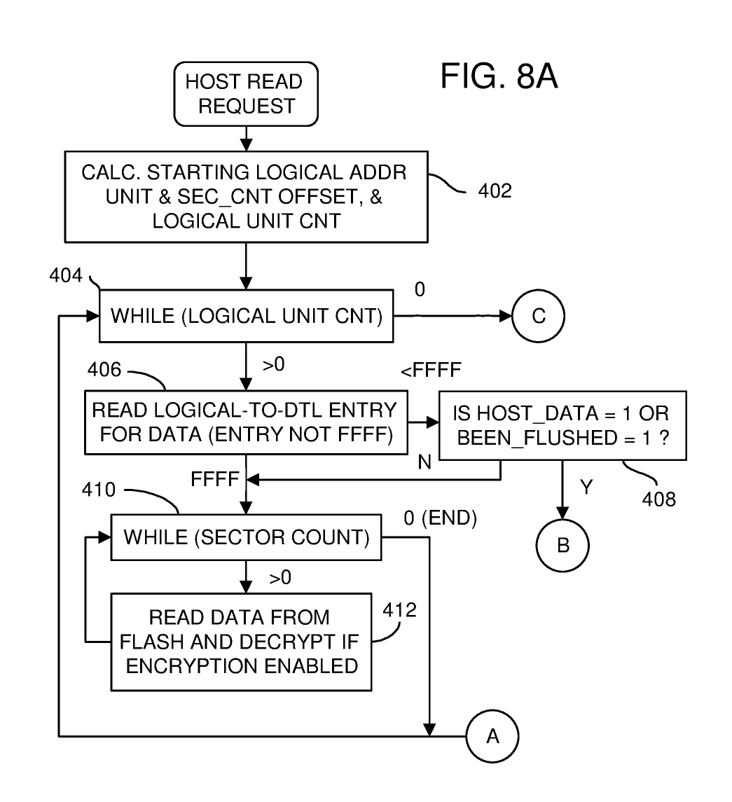

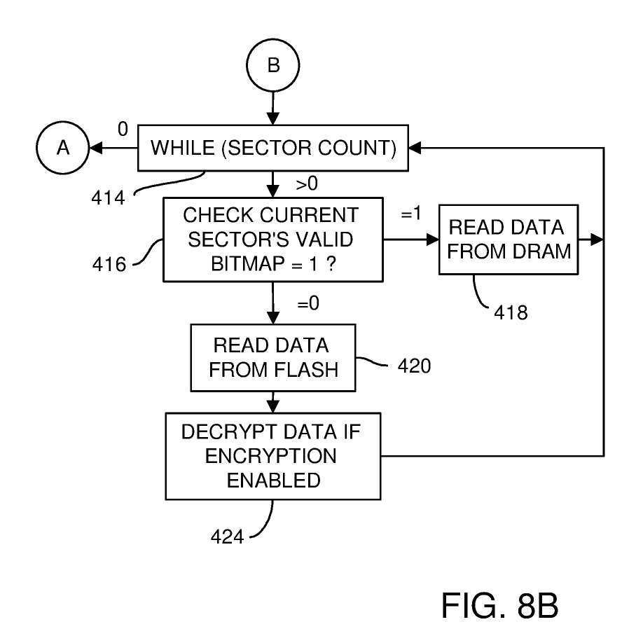

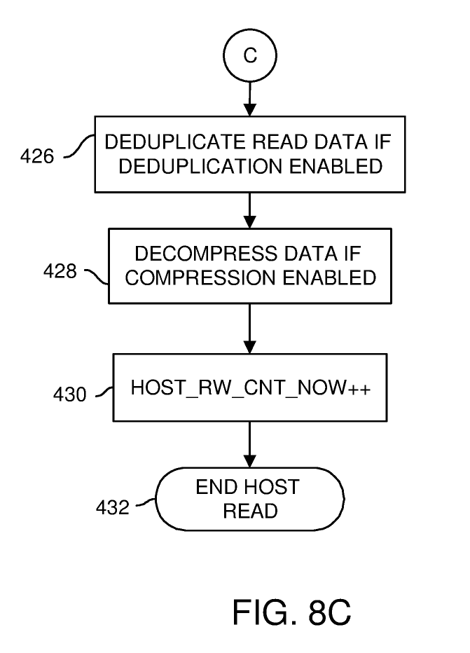

FIGS. 8A-C show a read operation using the mapping tables of FIGS. 5-7. In FIG. 8A, a host read request is received by the GNSD drive. GNSD controller 192 calculates the starting logical address unit # by dividing the logical address from the host by the number of sectors per DRAM unit, such as 256. The whole number result is the logical unit # and the remainder is the sector count offset. The logical unit count is the number of logical units needed to store all the sectors, and depends in the starting and ending sector offsets and the number of sectors read, step 402.

While the logical unit count is more than zero, step 404, logical-to-DTL table 303 is read using the logical address unit # as the address to find the corresponding entry, step 406. If that entry has a value of FFFF, it is not valid, and there is no data in SSD DRAM 194. The data must be read from flash memory 196.

While the sector count is above zero, step 410, the data for that sector is read from flash memory 196 and decrypted if encryption is enabled, step 412. The sector count is then decremented and the while loop repeated from step 410 until all sectors have been read from flash. Once all sectors have been read and the sector count is zero, step 410, then the logical unit # can be decremented and the next logical unit # checked, step 404. When there are no more logical units, step 404, the process continues on FIG. 8C.

When the entry in logical-to-DTL table 303 is not FFFF, step 406, the entry in logical-to-DTL table 303 is used to index into the DTL-to-logical table to find a corresponding entry. Status field 301 is read for that entry. When the host_data and been_flushed status bits are both zero, step 408, the entry is empty and has no data, so the data is read from flash using steps 410, 412. When either the host_data or the been_flushed status bit is set, step 408, the entry in the DTL-to-logical table indicates that there is valid data in SSD DRAM 194.

In FIG. 8B, valid data exists in SSD DRAM 194, at least for some sectors. While the sector count is above zero, step 414, the valid bit for that sector is read from sector valid bitmap 309, step 416. When the sector's valid bit is 1, the sector data is read from SSD DRAM 194, step 418. When the sector's valid bit is 0, the sector data is read from flash memory 196, step 420. The flash data is decrypted if encryption has been enabled, step 424.

The sector count is then decremented and the while loop repeated from step 414 until all sectors have been read from flash or DRAM. Once all sectors have been read and the sector count is zero, step 414, then the logical unit # can be decremented and the next logical unit # checked, step 404 of FIG. 8A.

When there are no more logical units, step 404 of FIG. 8A, the process continues on FIG. 8C. If deduplication is enabled, the read data is deduplicated, step 426. When deduplication is enabled, the data read from flash or DRAM may contain a pointer to the actual data. The actual data is read and returned to the host and the pointer discarded.

When compression is enabled, the data read from flash or DRAM is decompressed, step 428. The host read-write counter, host_rw_cnt_now, is incremented, step 430. The data is returned to the host and the host read operation ends, step 432.

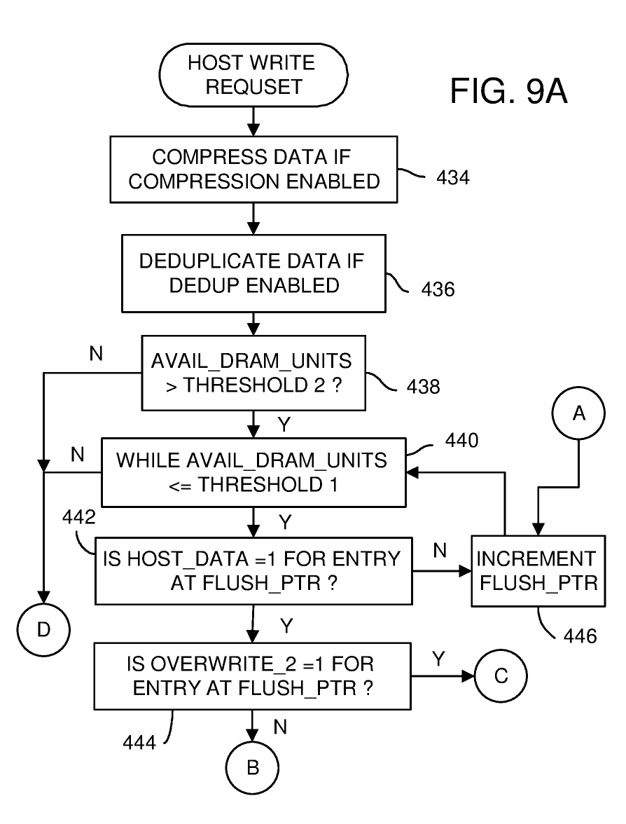

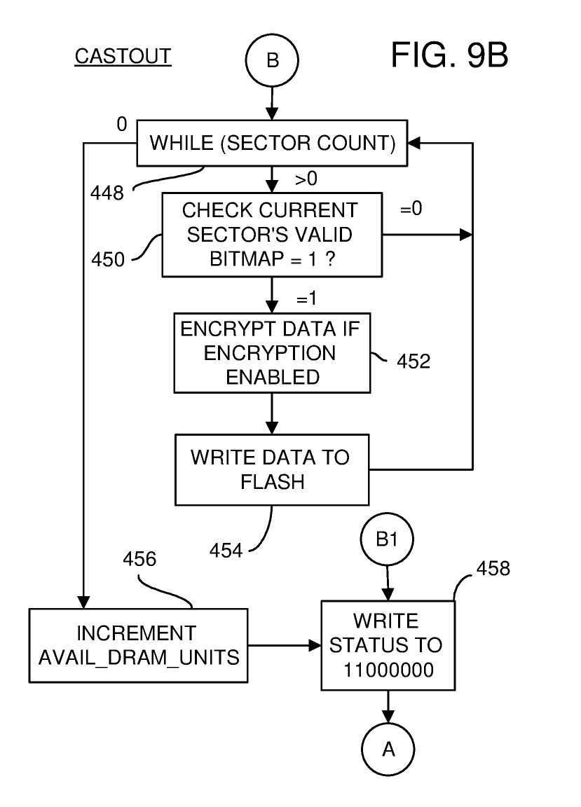

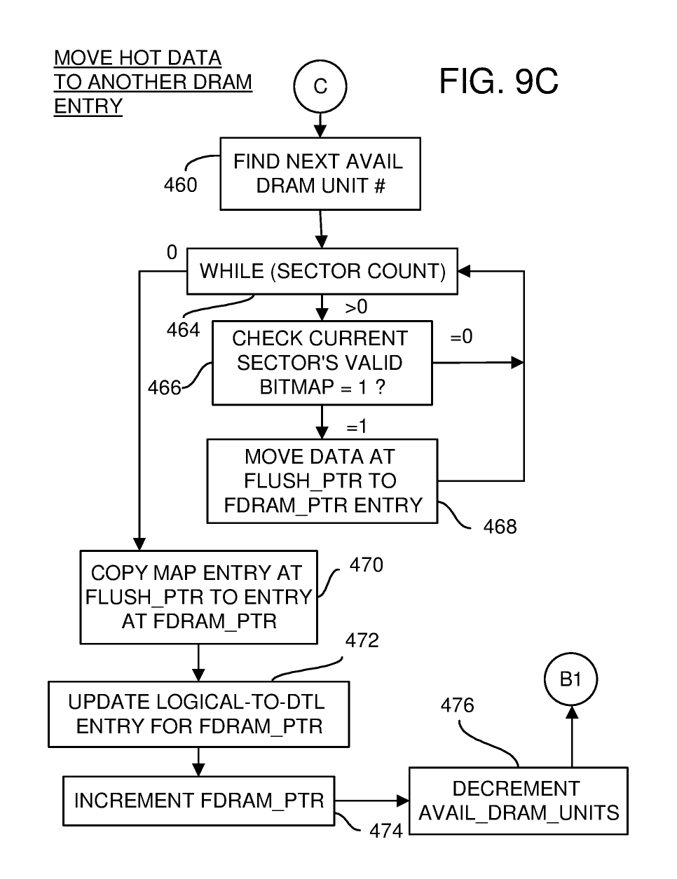

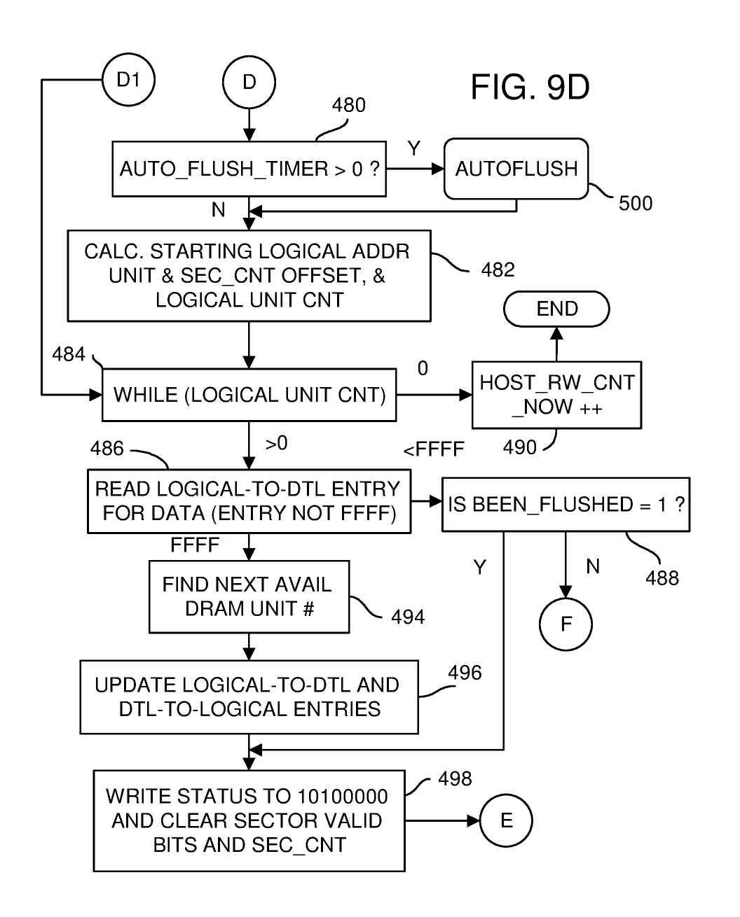

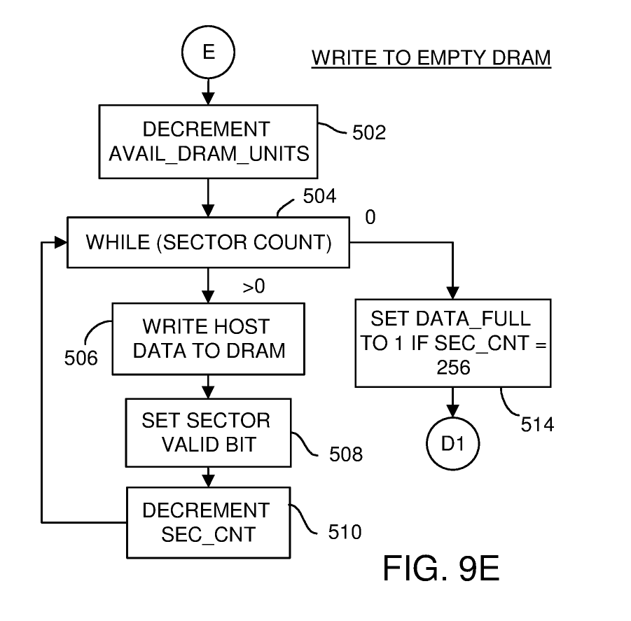

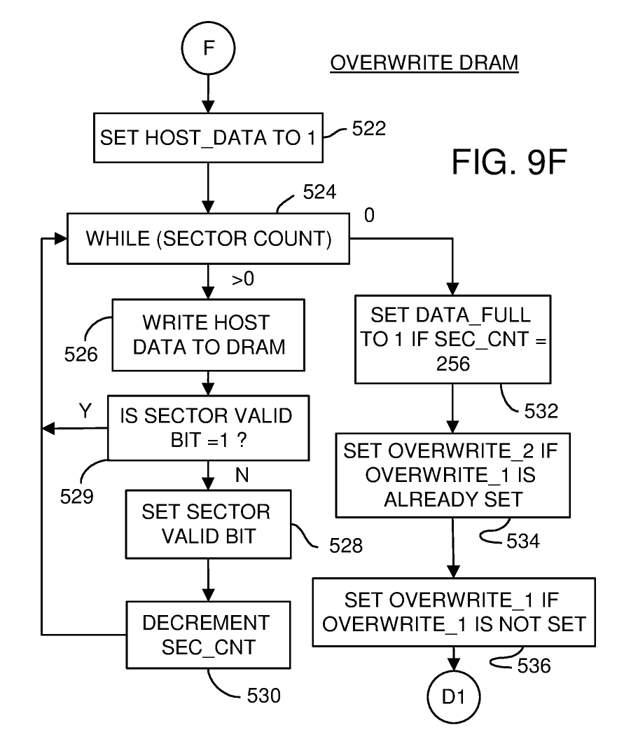

FIGS. 9A-F show a write operation using the mapping tables of FIGS. 5-7. In FIG. 9A, a host write request is received by the GNSD drive.

When compression is enabled, GNSD controller 192 compresses the write data from the host, step 434. If deduplication is enabled, the write data is deduplicated, step 436. When deduplication is enabled, the new write data can be compared to other older data that is already stored, and a pointer to that older data is substituted for the write data that is written to DRAM or flash.

The number of available DRAM units is determined. When the number of available DRAM units is more than threshold 2, step 438, or greater than threshold 1, step 440, the number of available DRAM units is adequate and does not need to be increased. The operation then continues in FIG. 9D with a check of the auto flush timer before writing the host data to SSD DRAM 194.

When the number of available DRAM units is less than threshold 2, step 438, and also not greater than threshold 1, step 440, the number of available DRAM units is too small and must be increased. A flush pointer is used to point to one of the entries in the DTL-to-logical table.

When status field 301 for that entry has host_data cleared to 0, step 442, then that entry is already available, so the flush pointer is incremented, step 446, and the loop repeated from step 440 to search for more entries that can be flushed.

When status field 301 for that entry has host_data set to 1, step 442, then that entry is not available since it is storing host data. When that entry's overwrite 2 bit is set, step 444, then that entry hold hot data that has been frequently written. This entry will be migrated to another open DRAM unit in FIG. 9C. Otherwise when the overwrite 2 bit is not set, step 444, the entry does not have frequently-written data and can be flushed to flash and the entry re-allocated to a different logical address.

Continuing in FIG. 9B, the data for the entry currently pointed to by the flush pointer is castout of SSD DRAM 194 and written into flash memory 196. The sector count is initialized to the maximum number of sectors that might be stored for the entry, which is 256. While the sector count is above 0, step 448, the bit for the current sector count is read from sector valid bitmap 309. When that bit is 0, step 450, then no data exists for that sector and the sector count can be decremented and the loop repeated from step 448.

When the current sector count's sector valid bitmap 309 sector bit is 1, step 450, then data exists for that sector. That sector's data is read from SSD DRAM 194 and encrypted if encryption is enabled, step 452. Then that sector of data is written to flash memory 196, step 454. Then the sector count can be decremented and the loop repeated from step 448.

Once all 256 sectors have been processed, the sector count reaches 0, step 448. The DRAM unit's entry has been flushed to flash memory 196 and is now available for other logical addresses. The counter for the number of available DRAM units is incremented, step 456. The status for this entry in the DTL-to-logical table is changed to 1100 0000 in status field 301 to indicate that the entry is valid and flushed, step 458. The process can then continue searching for more DRAM units with the next entry in the DTL-to-logical table after incrementing the flush pointer, step 446, and repeating the loop from step 440, FIG. 9A.

In FIG. 9C, overwrite 2 was set for the current entry pointed to by the flush pointer, as determined by step 444 of FIG. 9A. The current entry has frequently-written data and should be relocated within SSD DRAM 194 so that future accesses will find that frequently used data in DRAM rather than only in slower flash memory.

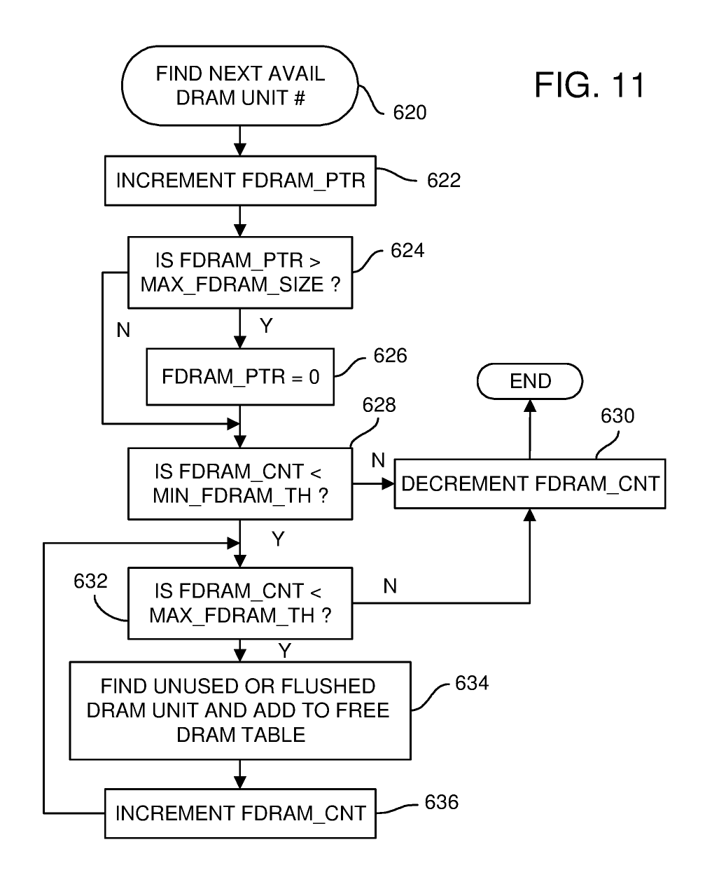

The next available DRAM unit is found, step 460, such as by using the routine of FIG. 11. The sector count is initialized to the maximum number of sectors that might be stored for the entry, 256. While the sector count is above 0, step 464, the bit for the current sector count is read from sector valid bitmap 309. When that bit is 0, step 466, then no data exists for that sector and the sector count can be decremented and the loop repeated from step 464.

When the current sector count's sector valid bitmap 309 sector bit is 1, step 466, then data exists for that sector. That sector's data is read from the entry that is pointed to by the flush pointer, and written to another entry that is pointed to by the free DRAM pointer, (FDRAM_PTR) step 468. Thus the frequently-used data is copied from the current entry to a different entry in SSD DRAM 194. Then the sector count can be decremented, and the loop repeated from step 464.

Once all 256 sectors have been processed, the sector count reaches 0, step 464. The DRAM unit's current entry has moved to a different entry in SSD DRAM 194 and the current entry is now available for other logical addresses. The mapping entry for the current entry pointed to by the flush pointer is copied to the entry pointed to by the free DRAM pointer, step 470. This copy includes DTL-to-logical address field 305, sector count field 307, sector valid bitmap 309, and status field 301. The new entry number pointed to by the free DRAM pointer is written into logical-to-DTL table 303 for the logical address that had pointed to the current entry, step 472. The free DRAM pointer can then be incremented, step 474, and the counter for the number of available DRAM units is decremented, step 476, to account for the new entry. The process then continues in FIG. 9B with step 458. The status for the old entry in the DTL-to-logical table is changed to 1100 0000 in status field 301 to indicate that the entry is valid and flushed, step 458. The process can then continue searching for more DRAM units with the next entry in the DTL-to-logical table after incrementing the flush pointer, step 446, and repeating the loop from step 440, FIG. 9A.

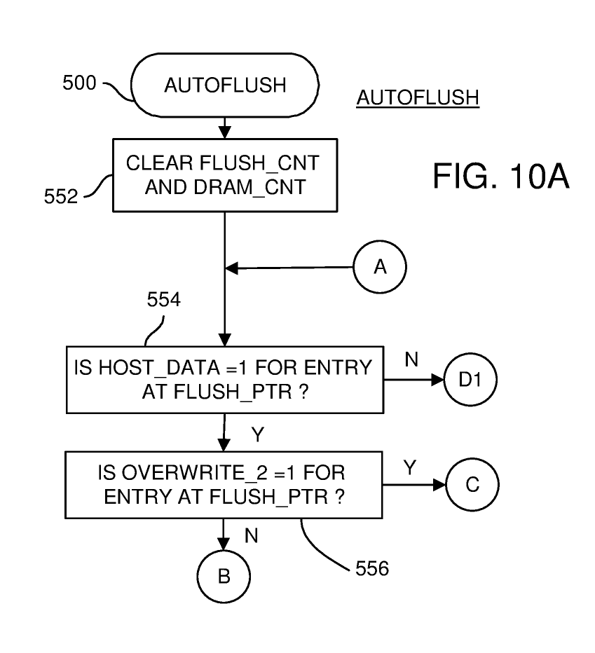

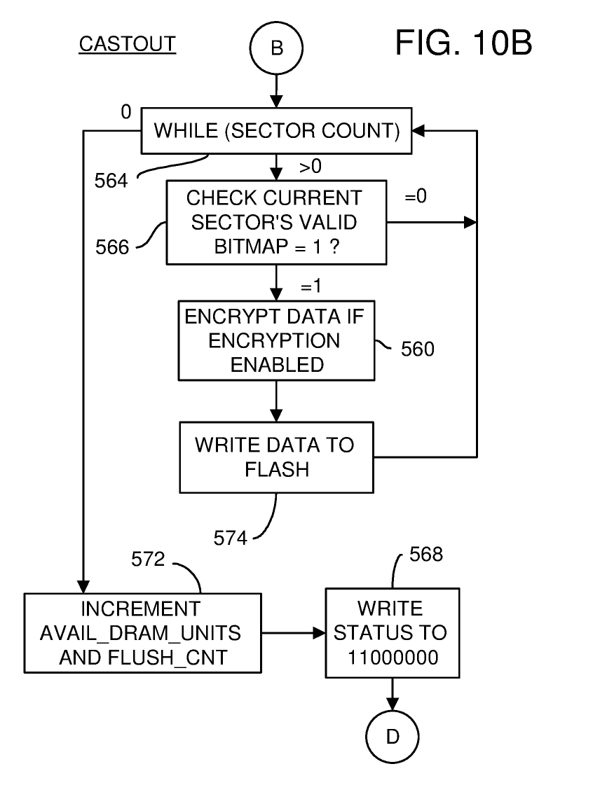

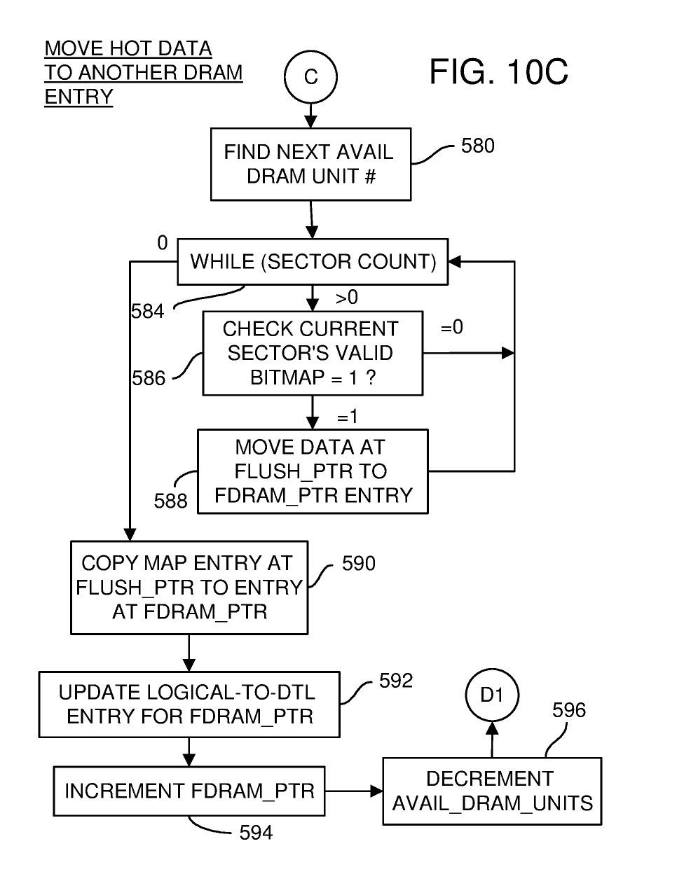

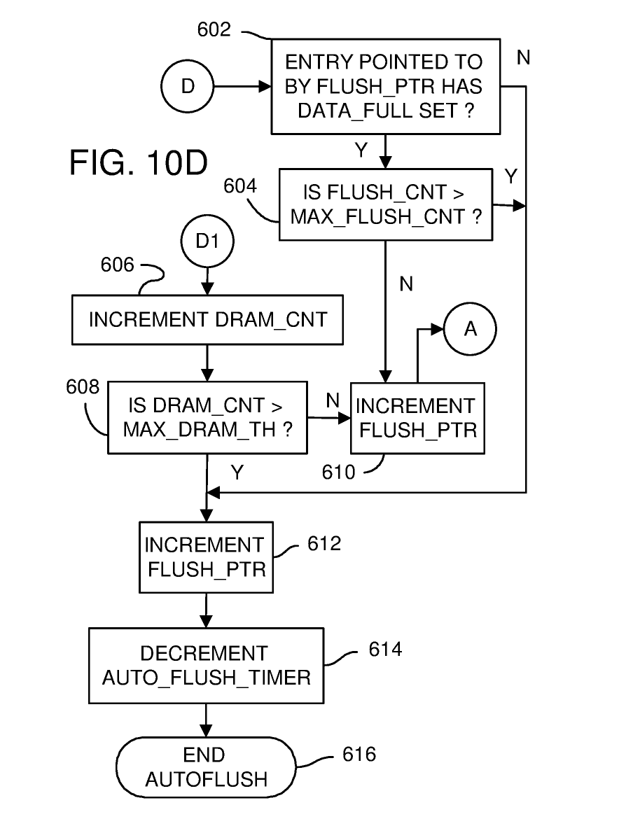

In FIG. 9D, the number of available DRAM units is adequate and does not need to be increased. The operation continues from FIG. 9A with a check of the auto flush timer, step 480, before writing the host data to SSD DRAM 194. When the auto flush timer is more than zero, auto flush routine 500 is activated (FIG. 10A-D).

GNSD controller 192 calculates the starting logical address unit # by dividing the logical address from the host by the number of sectors per DRAM unit, such as 256. The whole number result is the logical unit # and the remainder is the sector count offset. The logical unit count is the number of logical units needed to store all the sectors, and depends in the starting and ending sector offsets and the number of sectors written, step 482.

When the logical unit count reaches zero, step 484, the host read-write counter, host_rw_cnt_now, is incremented, step 490. The host write operation ends.

While the logical unit count is more than zero, step 484, logical-to-DTL table 303 is read using the logical address unit # as the address to find the corresponding entry, step 486. If that entry has any value other than FFFF, the host logical address already maps to a valid entry and can store its data into SSD DRAM 194. If the been_flushed bit is not set in status field 301, step 488, then the entry will be overwritten with the new host data as shown in FIG. 9F.

If the been_flushed bit is set in status field 301, step 488, then the entry is already available since the write data has already been backed up to flash memory. The entry in the DTL-to-logical table has its status field 301 set to 1010 0000 to indicate that the entry is valid with the new host data, and all bits in sector count field 307 and in sector valid bitmap 309 are cleared, step 498. The process continues in FIG. 9E.

While the logical unit count is more than zero, step 484, logical-to-DTL table 303 is read using the logical address unit # as the address to find the corresponding entry, step 486. If that entry has a value of FFFF, it is not valid, and there is no data in SSD DRAM 194. The write data must be allocated a new entry in the DTL-to-logical table.

The next available DRAM unit # is found, step 494, such as by using the routine of FIG. 11. The new entry number for this next available DRAM unit # is written into logical-to-DTL table 303 for the logical address from the host, step 496. DTL-to-logical address field 305 is written with the upper portion of the logical address from the host, which is the entry # in logical-to-DTL table 303. Thus the entries in logical-to-DTL table 303 and DTL-to-logical address field 305 are linked. The new entry in the DTL-to-logical table has its status field 301 set to 1010 0000 to indicate that the entry is valid with host data, and all bits in sector count field 307 and in sector valid bitmap 309 are cleared, step 498. The process continues in FIG. 9E.

In FIG. 9E, host write data is written to an empty DRAM unit. The number of available DRAM units is decremented, step 502, since a flushed or empty DRAM unit is being used. The sector count is initialized to 256. While the sector count is more than 0, step 504, the host data for that sector count is written to SSD DRAM 194, step 506. The sector valid bit for this sector count in sector valid bitmap 309 is set, step 508, and the sector count is decremented, step 510, before looping to step 504 for the next sector.

When the data write is for less than all 256 sectors in the DRAM unit, data is written and the valid bits set only for the sectors being written that are specified in step 482, using the sector offset and total sector count.

After all 256 sectors have been processed, the data_full bit is set if all 256 sectors have been written with valid data, step 514. The next logical unit, if any, is processed next with step 484 of FIG. 9D.

In FIG. 9F, host write data overwrites data already cached in a DRAM unit. The host_data status bit is set to 1 in the entry's status field 301, step 522.

The sector count is initialized to 256. While the sector count is more than 0, step 524, any host data for that sector count is written to SSD DRAM 194, step 526. If the sector valid bit in sector valid bitmap 309 is already set, step 529, the sector count is decremented and the next sector processed by looping back to step 524. Otherwise the sector valid bit for this sector count in sector valid bitmap 309 is set, step 528, and the sector count is decremented, step 530, before looping to step 524 for the next sector.

When the data write is for less than all 256 sectors in the DRAM unit, data is written and the valid bits set only for the sectors being written that are specified in step 482, using the sector offset and total sector count.

After all 256 sectors have been processed, and the sector count reaches 0, step 524, the data_full bit is set if all 256 sectors have been written with valid data, step 532. If the overwrite 1 bit is already set in status field 301, then the overwrite 2 bit is also set, step 534. If the overwrite 1 bit not set in status field 301, then the overwrite 1 bit is set, step 536. The next logical unit, if any, is processed next with step 484 of FIG. 9D.

FIGS. 10A-D shows an auto flush operation. Auto flush routine 500 is activated when the auto flush timer is greater than 0. The auto flush timer can count up or down periodically. When a lot of read and write operations occur, then the auto flush timer is reset to 0. When there are relatively few read and write operations, the auto flush timer is increased periodically.

In FIG. 10A, when auto flush routine 500 is activated, the flush count and the DRAM count are cleared, step 552. If the host_data bit is set in status field 301 for the entry pointed to by the flush pointer, step 554, and overwrite 2 is set, step 556, then the process continues in FIG. 10C for frequently-written data.

If the host_data bit is set in status field 301 for the entry pointed to by the flush pointer, step 554, and overwrite 2 is not set, step 556, then the process continues in FIG. 10B to castout the old entry and data.

If the host_data bit is not set in status field 301 for the entry pointed to by the flush pointer, step 554, then the process continues in FIG. 10D for an empty or already flushed entry.

In FIG. 10B, the data for the entry currently pointed to by the flush pointer is castout of SSD DRAM 194 and written into flash memory 196. The sector count is initialized to 256. While the sector count is above 0, step 564, the bit for the current sector count is read from sector valid bitmap 309. When that bit is 0, step 566, then no data exists for that sector and the sector count can be decremented and the loop repeated from step 564.

When the current sector count's sector valid bitmap 309 sector bit is 1, step 466, then data exists for that sector. That sector's data is read from SSD DRAM 194 and encrypted if encryption is enabled, step 560. Then that sector of data is written to flash memory 196, step 574. Then the sector count can be decremented and the loop repeated from step 564.

Once all 256 sectors have been processed, the sector count reaches 0, step 564. The DRAM unit's entry has been flushed to flash memory 196 and is now available for other logical addresses. The counter for the number of available DRAM units is incremented, step 572. The flush count is also incremented. The status for this entry in the DTL-to-logical table is changed to 1100 0000 in status field 301 to indicate that the entry is valid and flushed, step 568. The process continues in FIG. 10D.

In FIG. 10C, the old DRAM unit has frequently-accessed data and should be migrated to a different DRAM unit. The next available DRAM unit is found, step 580, such as by using the routine of FIG. 11. The sector count is initialized to the maximum number of sectors that might be stored for the entry, 256. While the sector count is above 0, step 584, the bit for the current sector count is read from sector valid bitmap 309. When that bit is 0, step 586, then no data exists for that sector and the sector count can be decremented and the loop repeated from step 584.

When the current sector count's sector valid bitmap 309 sector bit is 1, step 586, then data exists for that sector. That sector's data is read from the entry that is pointed to by the flush pointer, and written to another entry that is pointed to by the free DRAM pointer, (FDRAM_PTR) step 588. Thus the frequently-used data is copied from the current entry to a different entry in SSD DRAM 194. Then the sector count can be decremented, and the loop repeated from step 584.

Once all 256 sectors have been processed, the sector count reaches 0, step 584. The DRAM unit's current entry has moved to a different entry in SSD DRAM 194 and the current entry is now available for other logical addresses. The mapping entry for the current entry pointed to by the flush pointer is copied to the entry pointed to by the free DRAM pointer, step 590. This copy includes DTL-to-logical address field 305, sector count field 307, sector valid bitmap 309, and status field 301. The new entry number pointed to by the free DRAM pointer is written into logical-to-DTL table 303 for the logical address that had pointed to the current entry, step 592. The free DRAM pointer can then be incremented, step 594, and the counter for the number of available DRAM units is decremented, step 596, to account for the new available entry. The process continues in FIG. 10D.

In FIG. 10D, the processes of FIGS. 10A, 10B and 10C continue. The castout process of FIG. 10B continues with step 602. When the entry pointed to by the flush counter has data_full set, step 602, and the flush count is less than the maximum flush count, step 604, then the flush pointer is incremented, step 610, and the process repeated from FIG. 10A for a different entry in the DTL-to-logical table.

When the entry pointed to by the flush counter has data_full not set, step 602, or when the flush count is greater than the maximum flush count, step 604, then the flush pointer is incremented, step 612, and the auto flush timer is decremented, step 614. The auto flush process then ends, step 616.

When host_data is not set, step 554 (FIG. 10A), or after hot data has been moved to another DRAM unit (FIG. 10C), then the DRAM counter is incremented, step 606. When the DRAM counter is greater than the maximum DRAM threshold, step 608, then the flush pointer is incremented, step 612, and the auto flush timer is decremented, step 614. The auto flush process then ends, step 616.

When the DRAM counter is not greater than the maximum DRAM threshold, step 608, then the flush pointer is incremented, step 610, and the process repeated from FIG. 10A for a different entry in the DTL-to-logical table.

FIG. 11 is a routine to find a next available DRAM unit. Find next available DRAM unit # routine 620 is called by step 460 of FIG. 9C, step 494 of FIG. 9D, and step 580 of FIG. 10C. The free DRAM pointer is incremented, step 622, and cleared, step 626, when the free DRAM pointer is greater than the free DRAM size, step 624.

When the free DRAM count is not less than the minimum free DRAM count, step 628, then the free DRAM count is decremented, step 630, and the process ends.

When the free DRAM count is less than the minimum free DRAM count, step 628, but not less than the maximum free DRAM count, step 632, then the free DRAM count is decremented, step 630, and the process ends.

When the free DRAM count is less than the minimum free DRAM count, step 628, and also less than the maximum free DRAM count, step 632, then GNSD controller 192 searches for unused or flushed DRAM units by reading status field 301. These unused or flushed DRAM units are added to the free DRAM table, step 634. Then the free DRAM count is incremented, step 636, and again compared to the maximum free DRAM count, step 632.

The search process is not activated until the free DRAM count falls below the minimum, but once activated will continue to find unused or flushed DRAM units until the maximum is reached.

### Alternate Embodiments

Several other embodiments are contemplated by the inventors. For example, high-level ECC/LDPC controller 135 can use ECC or LDPC (low-density parity-check) to provide a higher-level protection of data by generating additional bits of ECC protection by calculating LDPC codes and storing them in a spare area of flash memory 196. When the protected data reads with an error, i.e., the data cannot be recovered by GNSD controller 192, the stored corresponding ECC/LDPC codes can be read and used to make the correction. Thus, using an efficient ECC like LDPC can improve endurance. Note that, in addition to graph-based codes like LDPC, algebraic codes such as, without limitation BCH, Hamming, and Reed-Solomon codes. LDPC codes, though, tend to be faster to generate and use fewer bits to protect the same size of data than other codes.

Full may refer to being within some threshold of full. Many encodings of the data-type bits and other status fields, pointers, etc. are possible. Entries could be linked to entries in other tables, such as having a separate table for tags or valid bits. Temporary files could have a variety of extensions, and new extensions could be added to the list to search for. Temporary files created by well-known programs such as word processors and internet browsers have well-known files extensions, but additional extensions may be added at any time. These additional file extensions could be added through firmware updates to the control software for GNSD and SSD controllers, or by firmware updated to GNSD application 180.

The size of DRAM buffer used by each part of DTL may be fixed by the firmware of the SSD controller. The each part of DTL also can be dynamically adjusted by the controller firmware automatically or manually based on the usage or preference of the user. Due to the limited size of DRAM buffers, not all DTL functions may be accommodated in it at the same time. The various DTL functions may be adaptive to the real working environment. The controller may adjust the size used by each DTL to optimize the DRAM buffer. The adaptive adjustment can be done periodically based on the usage patterns of the device.

For a flash device, the DRAM buffer can be substituted with NVRAM such as phase-change memory (PCM), ferroelectric random-access memory (FRAM), Magnetoresistive RAM (MRAM), Memristor, PRAM, Resistive RAM (RRAM), Racetrack memory, and nano RAM (NRAM) etc. The advantage of NVRAM is that all the DTL supported tables etc. may remain in NVRAM (no need to put in the flash memory) and other flash memory destined data (such as data write cache etc.) is retained even with power off, so the backup power circuit is no longer needed even when power is turned off suddenly. A tmp etc. & mapping table, and read cache & mapping tables can be optionally discarded at the power down or at the next power up initialization.

In the SSD device, the DRAM buffer also can be substituted with combinations such as DRAM+SRAM, DRAM+MLC, DRAM+PCRAM or DRAM+MRAM. When combinations of DRAM buffering is used such as DRAM+MLC, the DTL supported functions are managed in DRAM but some of them are stored in flash. Some of the data in the DRAM buffer can be discarded eventually such as temp. data and mapping tables, and read cache and mapping tables, that are not moved to flash when power is off. Tables and data that need to be kept when power is off such as the block erase count table, the page Status table, S.M.A.R.T. data collector, etc. need to be stored to flash when power is turned off suddenly.

In case of server applications, temp. data and mapping tables, and read cache and mapping tables cannot be discarded; those areas will be stored to flash using power backup when power is turned off suddenly. Another way is to insure the data of interest in DTL of the DRAM is copied to the MLC. In case of a power off, a valid copy of data in DTL can be kept in flash. At power up, the data in DTL can be loaded back to DRAM from flash. The copying method can be modified by recording the minor differences, which will reduce the amount of copying data and therefore reduce the writes to flash.

DRAM and Multi-Level-Cell (MLC) or DRAM and Single-Level-Cell (SLC) do not necessary use different types of flash memory 196, such as SLC, MLC, TLC, QLC, PLC, 3D NAND etc. Instead, the MLC can be derived from the Triple-Level-Cell (TLC) by allocating a part of the TLC that only has strong pages programmed. The SLC can be derived from MLC, TLC, QLC, PLC, etc. by allocating part of the MLC, TLC, QLC, PLC, etc. that only has strong pages programmed. For example, an Enhanced TLC Flash can be realized by a portion of TLC configured as SLC (with strong pages) using such as one quarter of the TLC used as SLC (strong page) and the reminder of TLC as TLC (weak page). Or a portion of TLC configured as MLC (strong page) and the reminder of TLC as TLC (weak page). Additionally, a program/erase manager may slow down page writing and block erasing time to help prolong the life of the oxide layer of cells of the flash. The slower page write/block erase time can be applied to the Enhanced TLC Flash to increase the endurance at the expense of decreased retention time. By using refresh manager 202, the retention time can be increased. Due to the Enhanced TLC Flash including SLC (strong page) and TLC (weak page) and with differing retention times, refresh manager 202 can track the usage of blocks as SLC (strong page) or TLC (weak page) and then adjust the refresh time accordingly. Alternatively, an enhanced TLC Flash can be realized by a portion of TLC configured as SLC (strong page) usage such as one quarter of TLC used as SLC (strong page). Similarly, MLC can be used as combination of SLC (strong page)/MLC (weak page) and QLC can be used as combinations such as SLC (strong page)/QLC (weak page), MLC (strong page)/QLC (strong page), TLC (strong page)/QLC (strong page), or any combination of SLC/MLC/TLC/QLC. Alternatively, MLC can be used as SLC (strong page), etc. The above functions also can be implemented in GNSD SSD 200.

The endurance technologies described herein attempt to solve the endurance issues of NAND flash memory. There are several non-volatile memories, such as MRAM, PCM, RRAM, Memristors, NRAM, etc. which are using competing technologies to replace NAND flash memory.

The SSD can be combined with a Hard Disk Drive (HDD), with a SSD as the cache and HDD as storage. The GNSD SSD is of high endurance and is a better fit as a cache. The overall performance may improve for this hybrid device. Another way to insure the data of interest in DTL of DRAM is copying to the HDD. In case of power off, a valid copy of data in DTL can be kept in HDD. At power up, those data in DTL can be loaded back to DRAM from HDD. The copying method can be modified by recording the minor differences which will reduce the amount of copying data and therefore reduce the writes to HDD.

The grouping of write data is not limited to a page as a unit. Grouping data can be in a larger unit such as multiple-pages (meta-pages) and whole blocks, etc.

While categorization of the data-type of a host access has been described as comparing the logical address from the host to one or more address ranges, this compare may compared only a portion of the logical address to ranges that represent the address ranges. Data types could also be identified by parsing the host write data for certain formats, such as a FAT format or a FDB format. Earlier host writes in a sequence could also be checked for their data formats. The FAT file system has been used as an example. FDB/FAT are the meta data of the FAT file system. Other file systems such as LINUX, Apple OS, and Android etc., have their own meta data with different names but are equivalents.

The DRAM unit may be a block or several blocks in size. Each block may be divided into multi-page zones. For example, a block may have 16 pages and 4 zones, with 4 pages per zone. Some of the mapping may be for zones rather than for individual pages or blocks in this alternative embodiment. Alternatively, in a special case, there can be one page per zone. Fewer mapping entries are needed with zone-mode than for page-mode, since each zone is multiple pages.

The upper bits of the logical-sector address (LSA) from the host may select a cluster or district. All of the entries in a mapping table may be for the same district. When the district number from the LSA matches the district number of all the entries in the mapping table, the LBA from the LSA selects an entry in the mapping table. Hybrid or multi-level mapping tables may also be used. Since the LBA ranges for the FAT1/2 are known, the table contents data type bits “100” can be omitted. The Mapping table can have a granularity of block or page.

Copying of blocks for relocation is less frequent with page mapping since the sequential-writing rules of the non-SLC flash are violated less often in page mode than in block mode. This increases the endurance of the flash system and increases performance.

The mapping tables may be located in an extended address space, and may use virtual addresses or illegal addresses that are greater than the largest address in a user address space. Pages may remain in the host's page order or may be remapped to any page location. In another embodiment such as for data center applications, the paging and temporary files can be treated as normal user data to simplify the controller operation but with the expense of flash endurance. The endurance spare/swap area can provide extended over-provisioning by using a DRAM buffer as endurance spare/swap buffer instead of using flash memory. The compression function can be optionally turned off in situations when the host is already providing a compression function. In other embodiments, the controller can treat the paging file as user data file to simplify the controller function.

Many variations of the block diagrams are possible. A ROM such as an EEPROM could be connected to or part of a controller and be dedicated to storing firmware for a virtual storage processor. This firmware could also be stored in the main flash modules. The Host interface bus can be a Serial AT-Attachment (SATA) bus, a Peripheral Components Interconnect Express (PCIe) bus, a compact flash (CF) bus, or a Universal-Serial-Bus (USB), NVMe, a Firewire 1394 bus, a Fibre Channel (FC) bus, Thunderbolt, etc. Internal buses may use standards such as for a Serial AT-Attachment (SATA) bus, an integrated device electronics (IDE) bus, a Peripheral Components Interconnect Express (PCIe) bus, a compact flash (CF) bus, a Universal-Serial-Bus (USB), a Secure Digital (SD) bus, a Multi-Media Card (MMC) bus, a Firewire 1394 bus, a Fibre Channel (FC) bus, various Ethernet buses, etc. SCFD can include SLC or MLC flash only or can be combined SLC/MLC flash.

The flash memory may be embedded on a motherboard or SSD board or could be on separate modules. Capacitors, buffers, resistors, and other components may be added. The controller may be integrated on the motherboard or on a separate board or module. Flash memory can be integrated with the controller or with raw-NAND flash memory chips as a single-chip device or a plug-in module or board.

Using multiple levels of controllers, such as in a president-governor arrangement of controllers, the controllers in the GNSD SSD may be less complex than would be required for a single level of control for wear-leveling, bad-block management, re-mapping, caching, power management, etc. Less expensive hardware may be used in the controller, such as using an 8051 processor for a controller or a virtual storage processor or a transaction manager, rather than a more powerful processor core such as a an Advanced RISC Machine ARM-9 CPU core. For a certain applications, a more powerful processor is considered.

Different numbers and arrangements of flash storage blocks can connect to the GNSD SSD. Rather than use a LBA storage bus interface or differential serial packet buses, other serial buses such as synchronous Double-Data-Rate (DDR), ONFI, Toggle NAND, a differential serial packet data bus, a legacy flash interface, etc.

A transaction manager, controllers, processes, and functions can be implemented in a variety of ways. Functions and processes can be programmed and executed by an embedded CPU or other processor, or can be implemented in dedicated hardware, firmware, or in some combination. Many partitionings of the functions can be substituted. The GNSD SSD controller may be hardware, or may include firmware or software or combinations thereof.

Overall system reliability is greatly improved by employing Parity/ECC with multiple flash channels, and stripping data segments into a plurality of NVM blocks. For example, a ninth flash chip can be used with the flash memory interface. The Parity of the other eight flash chips is written to this ninth flash chip to provide extra protection of data in case one of the eight flash chips encounters a fatal read error. However, it may require the usage of a CPU engine with a DDR/SDRAM cache in order to meet the computing power requirement of the complex ECC/Parity calculation and generation. Another benefit is that, even if one flash block or flash module is damaged, data may be recoverable, or the GNSD SSD can initiate a “Fault Recovery” or “Auto-Rebuild” process to insert a new flash module, and to recover or to rebuild the “Lost” or “Damaged” data. The overall system fault tolerance is significantly improved.

The flash cell's floating gate is programmed by injection of electrons into it. The flash memory controls the injection of electrons at page write so that it stays within two reference voltage levels. The NAND flash structure's bit-lines are connected to a string of 32 cells and each cell is also connected to 32 different word-lines. After a cell is written with data, any write and read to the adjacent cells will cause interference to the cell. The interference will either inject or remove electrons from the floating gate of the cell. A long period of time will also affect the number of electrons in the floating gate of the cell. Due to the changing of the quantity of electrons in the floating gate, the output voltage level will shift accordingly when read. If the output voltage level shifts across the reference voltage boundary, the read result will be wrong.

Wider or narrower data buses and flash-memory chips could be substituted, such as with 16 or 32-bit data channels. Alternate bus architectures with nested or segmented buses could be used internal or external to the GNSD SSD. Two or more internal buses can be used in the GNSD SSD to increase throughput. More complex switch fabrics can be substituted for the internal or external bus.

Data striping can be done in a variety of ways, as can parity and error-correction code (ECC). Packet re-ordering can be adjusted depending on the data arrangement used to prevent re-ordering for overlapping memory locations. The GNSD SSD can be integrated with other components or can be a stand-alone chip.

Additional pipeline or temporary buffers and FIFO's could be added. Separate page buffers could be provided in each channel. A clock source could be added.

A single package, a single chip, or a multi-chip package may contain one or more of the plurality of channels of flash memory and/or the GNSD SSD or SSD. The invention is not limited to the usage of SCFD. SCFD can be replaced with any kind of nonvolatile device with nonvolatile flash memory and a controller.

A MLC-based flash device may have four MLC flash chips with two parallel data channels, but different combinations may be used to form other flash modules, for example, four, eight or more data channels, or eight, sixteen or more MLC chips. The flash devices and channels may be in chains, branches, or arrays. For example, a branch of 4 flash devices could connect as a chain to the GNSD SSD. Other size aggregation or partition schemes may be used for different access of the memory.

The host can be a desktop PC motherboard or other PC platform such as a server, a Notebook, a Netbook, a tablet, a smart phone, a mobile communication device, a personal digital assistant (PDA), a digital camera, a production tool or tester, a combination device, or other device. The host bus or host-device interface can be SATA, PCIE, Thunderbolt, SD, USB, NVMe, eMMC, iSSD, or other host bus, while the internal bus to a flash module can be PATA, multi-channel SSD using multiple SD/MMC, compact flash (CF), USB, or other interfaces in parallel. A flash module could be a standard PCB or may be a multi-chip modules packaged in a TSOP, BGA, LGA, COB, PIP, SIP, CSP, POP, or Multi-Chip-Package (MCP) packages and may include raw-NAND flash memory chips or raw-NAND flash memory chips may be in separate flash chips, or other kinds of NVM flash memory such as toggle, ONFI, eMMC, iSSD, 3D NAND. GNSD SSD may use eMMC with a RAID and eMMC may use a GNSD SSD structure. The internal bus may be fully or partially shared or may be separate buses. The SSD system may use a circuit board with other components such as LED indicators, capacitors, resistors, etc. Power management may be added at one or more levels. The GNSD SSD can work with or without a VMD driver. A PCIe RAID DRAM cache card may incorporate a VMD driver and multiple GNSD SSD structured SSD's.

Directional terms such as upper, lower, up, down, top, bottom, etc. are relative and changeable as the system or data is rotated, flipped over, etc. These terms are useful for describing the device but are not intended to be absolutes.

NVM flash memory may be on a flash module that may have a packaged controller and flash die in a single chip package that can be integrated either onto a PCBA, or directly onto the motherboard to further simplify the assembly, lower the manufacturing cost and reduce the overall thickness. Flash chips could also be used with other embodiments including the open frame cards.

Rather than use a controller only for flash-memory storage, additional features may be added. For example, a music player may include a controller for playing audio from MP3 data stored in the flash memory. An audio jack may be added to the device to allow a user to plug in headphones to listen to the music. A wireless transmitter such as a BlueTooth transmitter may be added to the device to connect to wireless headphones rather than using the audio jack. Infrared transmitters such as for IrDA may also be added. A BlueTooth transceiver to a wireless mouse, PDA, keyboard, printer, digital camera, MP3 player, or other wireless device may also be added. The BlueTooth transceiver could replace the connector as the primary connector. A Bluetooth adapter device could have a connector, a RF (Radio Frequency) transceiver, a baseband controller, an antenna, a flash memory (EEPROM), a voltage regulator, a crystal, a LED (Light Emitted Diode), resistors, capacitors and inductors. These components may be mounted on the PCB before being enclosed into a plastic or metallic enclosure.

The size of data such as sectors, pages, blocks may vary. A sector may have 512 bytes, a page may have 16 sectors, and a block may have 128 pages as one of many examples.

The write data in the DTL alternatively can be packed and logged one-by-one to the data write cache as a page unit by the flash controller. The packed data size from the host can be either a large size such as more than a meta-page unit or a small size such as less than a sector. A header is added the show the relation of the data to the LBA from host. A separate packed table maps the LBA from the host to the offset location of the data and header in the meta-page unit of the data write cache. The data write cache can have a capacity of more than two meta-page units in size. When the data write cache is full or an elapsed time is reached, a selected meta-page unit will be moved to the flash memory from the data write cache. The packed table maps the LBA from the host to the offset location of the data and header in the meta-page unit of the flash memory. In the case of overwriting old data from host, if the packed data is still in the data write cache, the old data can be discarded by moving the packed data up and appending the new updated data into the data write cache and updating the packed table. Otherwise, if the packed data is in the flash memory, the new and old data will be compared and a delta data will be generated to show the difference. The delta data and its header will be appended to the data write cache. The new header will also include the previous old data location. The packed table will map the LBA to the delta data position.

The background of the invention section may contain background information about the problem or environment of the invention rather than describe prior art by others. Thus inclusion of material in the background section is not an admission of prior art by the Applicant.

Any methods or processes described herein are machine-implemented or computer-implemented and are intended to be performed by machine, computer, or other device and are not intended to be performed solely by humans without such machine assistance. Tangible results generated may include reports or other machine-generated displays on display devices such as computer monitors, projection devices, audio-generating devices, and related media devices, and may include hardcopy printouts that are also machine-generated. Computer control of other machines is another tangible result.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claim elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A Green NAND Solid-State Drive (GNSD) device comprising:
a flash memory for storing data;
a flash translation layer for accessing the flash memory;
a Solid-State Drive (SSD) dynamic-random-access memory (DRAM) for storing mapping tables and data;
a DRAM Translation Layer (DTL) for controlling access to the SSD DRAM;
a GNSD controller comprising:
a memory manager for managing the mapping table, the mapping table being accessed when the host reads and writes data, the mapping table indicating when host data resides in the SSD DRAM and when the host data resided only in the flash memory; and
a write control routine executed by the GNSD controller in response to a host write, the write control routine comparing a number of available entries in the mapping table.

2. The GNSD device of claim 1 further comprising:
a mapping table for managing access to the SSD DRAM that comprises:
a logical-to-DTL table having entries that are selected by an upper portion of a logical address received from a host, each entry containing a DTL pointer;
a DTL-to-logical table having a plurality of entries that are selected by the DTL pointer;
wherein a plurality of sectors are stored in the SSD DRAM for an entry in the plurality of entries.

3. The GNSD device of claim 1 further comprising:
wherein the write control routine is further for comparing the number of available entries in the mapping table to a first threshold and to a second threshold;
wherein when the number of available entries is below both the first and the second thresholds, the GNSD controller searches the mapping tables for available entries that can store new host write data and increases the number of available entries in the mapping table that can store new host write data for each new available entry created until the number of available entries in the mapping table that can store new host write data is larger than the second threshold; and
wherein the second threshold is larger than the first threshold.

4. The GNSD device of claim 1 further comprising:
an auto flush timer;
in response to the auto flush timer, the GNSD controller executes an auto flush routine to flush write data from the SSD DRAM into the flash memory to increase the number of available entries that can store new host write data.

5. The GNSD device of claim 2 wherein each entry in the DTL-to-logical table comprises:
a DTL-to-logical address field that stores the upper portion of the logical address received from the host that selected a matching entry in the logical-to-DTL table that stores a DTL pointer that identifies the entry in the DTL-to-logical table;
a status field containing status bits indicating status of data stored for the entry;
a sector valid bitmap having a plurality of sector valid bits that each indicate validity of a sector stored for the entry;
a sector count field having a sector count that indicates a number of valid sectors being stored for the entry;
wherein the sector count matches a total number of sector valid bits in a valid state in the sector valid bitmap for the entry.

6. The GNSD device of claim 5 wherein the mapping tables further comprise entries each with a status field that comprise:
a host data bit that indicates that host data has been written into the SSD DRAM for the entry;
a first overwrite bit that is set when a second host write occurs to an entry that has the host data bit set;
a second overwrite bit that is set when a third host write occurs to an entry that has the host data bit set.

7. The GNSD device of claim 6 wherein the memory manager retains data in the SSD DRAM for entries that have the second overwrite bit set and instead casts out entries that do not have the second overwrite bit set when the memory manager increases the number of available entries in the mapping table that can store new host write data.

8. The GNSD device of claim 5 wherein the status bits stored in the status field comprise:
a data valid bit indicating that the entry is configured for storing data;
a null queue bit indicating that the entry is empty of data;
a been flushed bit indicating that the entry has write data that has been copied to the flash memory;
a data full bit indicating that all possible sectors for the entry have been written with host write data.

9. The GNSD device of claim 1 further comprising:
a data write cache for caching host write data;
a data read cache for caching host read data;
a grouping engine for grouping data stored in the data write cache into meta-pages;
an un-grouping engine for un-grouping data in stored in meta-pages into ungrouped data for storage in the data read cache;
wherein meta-pages are sent from the grouping engine for transfer to the flash memory, and meta-pages stored in the flash memory are received by the un-grouping engine.

10. A Green NAND Solid-State Drive (GNSD) controller comprising:
a memory manager for accessing a Solid-State Drive (SSD) DRAM having a plurality of buffers managed by the memory manager;
a data write cache in the SSD DRAM for storing host write data;
a data read cache in the SSD DRAM for storing data for reading by the host;
a mapping table for managing access to the SSD DRAM that comprises:
a logical-to-DTL table having entries that are selected by an upper portion of a logical address received from the host, each entry containing a DTL pointer;
a DTL-to-logical table having a plurality of entries that are selected by the DTL pointer;
wherein a plurality of sectors are stored in the SSD DRAM for an entry in the plurality of entries.

11. The GNSD controller of claim 10 wherein each entry in the DTL-to-logical table comprises:
a DTL-to-logical address field that stores the upper portion of the logical address received from the host that selected a matching entry in the logical-to-DTL table that stores a DTL pointer that identifies the entry in the DTL-to-logical table;
a status field containing status bits indicating status of data stored for the entry;
a sector valid bitmap having a plurality of sector valid bits that each indicate validity of a sector stored for the entry; and
a sector count field having a sector count that indicates a number of valid sectors being stored for the entry;
wherein the sector count matches a total number of sector valid bits in a valid state in the sector valid bitmap for the entry.

12. The GNSD controller of claim 11 wherein the status bits stored in the status field comprise:
a data valid bit indicating that the entry is configured for storing data;
a null queue bit indicating that the entry is empty of data;
a been flushed bit indicating that the entry has write data that has been copied to the flash memory;
a host data bit that indicates that host data has been written into the SSD DRAM for the entry; and
a data full bit indicating that all possible sectors for the entry have been written with host write data.

13. The GNSD controller of claim 11 wherein the status bits stored in the status field further comprise:
a first overwrite bit that is set when a second host write occurs to an entry that has the host data bit set; and
a second overwrite bit that is set when a third host write occurs to an entry that has the host data bit set.

14. The GNSD controller of claim 13 wherein the memory manager retains data in the SSD DRAM for entries that have the second overwrite bit set and instead casts out entries that do not have the second overwrite bit set when the memory manager increases available space.

15. The GNSD controller of claim 10 further comprising:
a power monitor for detecting a power failure;
a flush manager for flushing data stored in the SSD DRAM to a flash memory when power is lost; and
a resume manager reloader for fetching flushed data from the flash memory to the SSD DRAM when power is restored.

16. The GNSD controller of claim 10 further comprising:
a DRAM Translation Layer (DTL) stored in the SSD DRAM, the DTL comprising:
a plurality of mapping tables for managing temp files, log files, paging files, and fetch data;
the data write cache;
the data read cache;
mapping tables used by the grouping engine; and
a block/erase count table.

17. The GNSD controller of claim 10 further comprising:
a transaction manager for logging events indicating start and completion of data writes to the flash memory; and
a recovery manager for reading events logged by the transaction manager to undo or redo writes to the flash memory after power resumes.

18. An integrated Green NAND Solid-State Drive (GNSD) controller comprising:
a memory manager with a DRAM Translation Layer (DTL) for controlling access to a Solid-State Drive (SSD) Dynamic-Random-Access Memory (DRAM);
a mapping table for managing access to the SSD DRAM that comprises:
a logical-to-DTL table having entries that are selected by an upper portion of a logical address received from a host, each entry containing a DTL pointer;
a DTL-to-logical table having a plurality of entries that are selected by the DTL pointer;
wherein a plurality of sectors are stored in the SSD DRAM for an entry in the plurality of entries;
wherein each entry in the DTL-to-logical table comprises:
a DTL-to-logical address field that stores the upper portion of the logical address received from the host that selected a matching entry in the logical-to-DTL table that stores a DTL pointer that identifies the entry in the DTL-to-logical table;
a status field containing status bits indicating status of data stored for the entry;
a sector valid bitmap having a plurality of sector valid bits that each indicate validity of a sector stored for the entry;
a sector count field having a sector count that indicates a number of valid sectors being stored for the entry;
wherein the sector count matches a total number of sector valid bits in a valid state in the sector valid bitmap for the entry;
wherein the status bits stored in the status field comprise:
a data valid bit indicating that the entry is configured for storing data;
a null queue bit indicating that the entry is empty of data;
a been flushed bit indicating that the entry has write data that has been copied to a flash memory;
a host data bit that indicates that host data has been written into the SSD DRAM for the entry;
a data full bit indicating that all possible sectors for the entry have been written with host write data;
a first overwrite bit that is set when a second host write occurs to an entry that has the host data bit set;
a second overwrite bit that is set when a third host write occurs to an entry that has the host data bit set;
wherein the memory manager retains data in the SSD DRAM for entries that have the second overwrite bit set and instead casts out entries that do not have the second overwrite bit set when the memory manager increases available space.

19. The integrated GNSD controller of claim 18 further comprising:
a data write cache for storing host write data;
a data read cache for storing data for reading by the host;
a grouping engine for grouping data stored in the data write cache into meta-pages;
an un-grouping engine for un-grouping data in stored in meta-pages into ungrouped data for storage in the data read cache;
wherein meta-pages are sent from the grouping engine to a volume manager for transfer to a flash memory, and meta-pages stored in the flash memory are received by the un-grouping engine;
a file priority tag sorter for generating a data type for a host write received;
a task policy assignor for assigning a priority to tasks including writing of host write data by the data type, wherein priority is a function of the data type from the file priority tag sorter;
a performance adjustor for adjusting priority of tasks; and
a target assignor for sorting host write data based on the data type generated by the file priority tag sorter.

20. The integrated GNSD controller of claim 18 further comprising:
a transaction system for logging events indicating start and completion of data writes to the flash memory;
a flush manager for flushing data stored in a SSD DRAM to a flash memory when power is lost; and
a resume manager reloader for fetching flushed data from the flash memory to the SSD DRAM when power is restored.

21. The integrated GNSD controller of claim 18 further comprising:
an encryption/decryption engine, coupled to receive host writes, for generating encrypted data and for decrypting encrypted data; and
a compression/decompression engine, coupled to receive host writes, for generating compressed data and for decompressing compressed data.
